(19) United States
(12) Patent Application Publication
(10) Pub. No.: US 2026/0016881 A1
(43) Pub. Date: Jan. 15, 2026

(54) ELECTRONIC DEVICE AND METHOD FOR CONTROLLING EXTERNAL SENSOR IN THE ELECTRONIC DEVICE

(71) Applicant: Samsung Electronics Co., Ltd., Suwon-si (KR)

(72) Inventors: Namjun CHO, Suwon-si (KR); Hyoseok NA, Suwon-si (KR)

(21) Appl. No.: 19/264,219

(22) Filed: Jul. 9, 2025

Related U.S. Application Data
(63) Continuation of application No. PCT/KR2025/009875, filed on Jul. 8, 2025.

(30) Foreign Application Priority Data
Jul. 9, 2024 (KR) 10-2024-0090688
Sep. 5, 2024 (KR) 10-2024-0120889

(51) Int. Cl. G06F 1/3287; G06F 1/16; G06F 1/3215; G06F 1/3234

(52) U.S. Cl. CPC G06F 1/3287; G06F 1/163; G06F 1/3215; G06F 1/3278

(57) ABSTRACT

An electronic device is provided. The electronic device includes communication circuitry, memory, including one or more storage media, storing instructions, and a processor communicatively coupled to the communication circuitry and the memory, wherein the instructions when executed by the processor, cause the electronic device to identify a first sensor of a first external electronic device and a second sensor of a second external electronic device corresponding to the first sensor based on communications with the first and second external electronic devices, identify whether the first sensor value is a valid value, when the first sensor value is received from the first external electronic device based on the first external electronic device being worn on a human body, and, based on identifying that the first sensor value is the valid value, change a first sensing time interval of the second sensor to a second sensing time interval greater than the first sensing time interval.

### CROSS-REFERENCE TO RELATED APPLICATION(S)

This application is a continuation application, claiming priority under 35 U.S.C. § 365 (c), of an International application No. PCT/KR2025/009875, filed on Jul. 8, 2025, which is based on and claims the benefit of a Korean patent application number 10-2024-0090688, filed on Jul. 9, 2024, in the Korean Intellectual Property Office, and of a Korean patent application number 10-2024-0120889, filed on Sep. 5, 2024, in the Korean Intellectual Property Office, the disclosure of each of which is incorporated by reference herein in its entirety.

### TECHNICAL FIELD

The disclosure relates to a method of controlling an external sensor by an electronic device.

### BACKGROUND ART

With the development of digital technology, electronic devices are provided in various forms, such as smartphones, tablet personal computers (PCs), and personal digital assistants (PDAs). Electronic devices have been developed in the form that can be worn by users to improve mobility and user accessibility, and are becoming compact and lightweight enough to be used without much inconvenience even when worn on the body.

The use of wearable electronic devices as electronic devices that are convenient to use in everyday life and are portable or wearable is increasing. For example, wearable electronic devices can be implemented in various forms, such as accessories like glasses (for example, smart glasses), watches (for example, smart watches), and rings (e.g., smart rings), clothing, or body implantation, and can be equipped with sensors (for example, a signal detection integrated chip (IC)) and can collect and provide sensing information, such as detailed information about the surrounding environment (for example, temperature, pressure, geomagnetic, global positioning system (GPS), or other environments) or sensing information, such as individual body changes (for example, biological signals) in real time through the sensor.

The above information is presented as background information only to assist with an understanding of the disclosure. No determination has been made, and no assertion is made, as to whether any of the above might be applicable as prior art with regard to the disclosure.

### DETAILED DESCRIPTION OF THE INVENTION

### Technical Solution

A wearable electronic device may operate using power of a battery, and the battery capacity may vary depending on the shape. A user may carry or wear a plurality of wearable devices having different battery capacities. When a plurality of wearable devices performs similar or the same sensing operation in the state in which the plurality of wearable devices is in use by the user, energy may be wasted due to the overlapping sensing operation. When each of the wearable electronic devices with different battery capacities performs similar or identical sensing operations, deactivating the sensing operation of the wearable electronic device with a small battery capacity, increasing the sensor operation cycle, and using sensing information for the sensing operation of the wearable electronic device with a large battery capacity may reduce energy waste and reduce power consumption of the wearable device with a small battery capacity to increase the use time.

For example, when a smart watch and a smart ring sense (or monitor) a similar or identical biometric signal while a user is wearing the smart watch and the smart ring, it is possible to reduce power consumption of the smart ring and increase the use time of the smart ring by deactivating a biometric signal sensing operation of a smart ring having a smaller size than the smart watch so as to have a small battery capacity or increasing the sensing operation period and using sensing information of the smart watch.

Aspects of the disclosure are to address at least the above-mentioned problems and/or disadvantages and to provide at least the advantages described below.

Accordingly, an aspect of the disclosure is to provide an electronic device capable of reducing power consumption by deactivating a sensor operation of an external electronic device with a low battery capacity among a plurality of external electronic devices or increasing a sensing operation period when an electronic device receives similar or identical biometric signals from each of the plurality of external electronic devices, and a method of controlling an external sensor by the electronic device.

Additional aspects will be set forth in part in the description which follows and, in part, will be apparent from the description, or may be learned by practice of the presented embodiments.

In accordance with an aspect of the disclosure, an electronic device is provided. The electronic device includes communication circuitry, memory, including one or more storage media, storing instructions, and at least one processor communicatively coupled to the communication circuitry and the memory, wherein the instructions, when executed by the at least one processor individually or collectively, cause the electronic device to identify a first sensor of a first external electronic device and a second sensor of a second external electronic device corresponding to the first sensor based on communications, through the communication circuitry, with the first external electronic device and the second external electronic device, identify whether a first sensor value is a valid value when the first sensor value sensed by the first sensor is received from the first external electronic device based on the first external electronic device being worn on a human body, based on identifying that the first sensor value is the valid value, transmit, to the second external electronic device through the communication circuitry, a sensor control signal to deactivate the second sensor or change a first sensing time interval of the second sensor to a second sensing time interval greater than the first sensing time interval.

In accordance with another aspect of the disclosure, an electronic device is provided. The electronic device includes communication circuitry, memory, including one or more storage media, storing instructions, and at least one processor, communicatively coupled to the communication circuitry and the memory, wherein the instructions, when executed by the at least one processor individually or collectively, cause the electronic device to identify a first sensor of the electronic device and a second sensor of a second external electronic device corresponding to the first sensor when the electronic device, through the communication circuitry, does not communicate with a first external electronic device and communicates with the second external electronic device, identify whether a first sensor value is a valid value when the first sensor value sensed by the first sensor is obtained based on identifying the electronic device being worn on a human body, transmit, to the second external electronic device through the communication circuitry, a sensor control signal to deactivate the second sensor or change a first sensing time interval of the second sensor to a second sensing time interval greater than the first sensing time interval, wherein the second sensing time interval is different from a sensing time interval corresponding to a sensor control signal received by the second external electronic device from the first external electronic device when the second external electronic device is connected to the first external electronic device.

In accordance with another aspect of the disclosure, a method of controlling an external sensor by an electronic device is provided. The method includes, based on communication between the electronic device and a first external electronic device and communication between the electronic device and a second external electronic device through communication circuitry, identifying a first sensor of the first external electronic device and a second sensor of the second external electronic device corresponding to the first sensor, in case that a first sensor value sensed by the first sensor is received from the first external electronic device, based on the first external electronic device being worn on a human body, identifying whether the first sensor value is a valid value, based on identifying that the first sensor value is the valid value, transmitting, to the second external electronic device through the communication circuitry, a sensor control signal for deactivating the second sensor or changing a first sensing time interval of the second sensor to a second sensing time interval greater than the first sensing time interval.

In accordance with another aspect of the disclosure, a method of controlling the external sensor by the electronic device is provided. The method includes, in case that the electronic device is not connected to communicate with a first external electronic device and is connected to communicate with a second external electronic device through communication circuitry, identifying a first sensor of the electronic device and a second sensor of the second external electronic device, corresponding to the first sensor, in case that a first sensor value sensed by the first sensor is acquired based on the electronic device being worn on a human body, identifying whether the first sensor value is a valid value, based on the first sensor value being the valid value, transmitting, to the second external electronic device through the communication circuitry, a sensor control signal for deactivating the second sensor or changing a sensing period of the second sensor to a second sensing time interval greater than a specified first sensing time interval.

In accordance with another aspect of the disclosure, one or more non-transitory computer-readable storage media storing one or more computer programs including computer-executable instructions that, when executed by at least one processor of an electronic device individually or collectively, cause the electronic device to perform operations are provided. The operations include, based on communication between the electronic device and a first external electronic device and communication between the electronic device and a second external electronic device through communication circuitry, identifying a first sensor of the first external electronic device and a second sensor of the second external electronic device, corresponding to the first sensor, in case that a first sensor value sensed by the first sensor is received from the first external electronic device, based on the first external electronic device being worn on a human body, identifying whether the first sensor value is a valid value, and, based on identifying that the first sensor value is the valid value, transmitting, to the second external electronic device through the communication circuitry, a sensor control signal for deactivating the second sensor or changing a first sensing time interval of the second sensor to a second sensing time interval greater than the first sensing time interval.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a diagram illustrating an electronic device and external electronic devices according to an embodiment of the disclosure;

FIG. 3 is a block diagram of a first external electronic device according to an embodiment of the disclosure;

FIG. 4 is a block diagram of a second external electronic device according to an embodiment of the disclosure;

FIG. 5 is a flowchart illustrating an operation in which an electronic device controls an external sensor according to an embodiment of the disclosure;

FIG. 6A is a flowchart illustrating an operation in which an electronic device, a first external electronic device, and a second external electronic device enters a first mode, a second mode, and a third mode according to an embodiment of the disclosure;

FIG. 6B is a flowchart illustrating an operation following after FIG. 6A according to an embodiment of the disclosure;

FIG. 7 is a flowchart illustrating an operation of controlling a sensor of a second external electronic device while an electronic device is connected to a first external electronic device and a second external electronic device according to an embodiment of the disclosure;

FIG. 8 is a flowchart illustrating an operation of controlling a sensor of a second external electronic device while a first external electronic device is not connected to an electronic device but is connected to a second external electronic device according to an embodiment of the disclosure;

FIG. 9 is a flowchart illustrating an operation in a state in which a second external electronic device is not connected to an electronic device and is not connected to a first external electronic device according to an embodiment of the disclosure;

FIG. 10A is a diagram illustrating a case in which each of a first external electronic device and a second external electronic device is worn on a human body in a state in which an electronic device is connected to communicate with each of the first external electronic device and the second external electronic device according to an embodiment of the disclosure;

FIG. 10B is a diagram illustrating a case in which a first external electronic device is not worn on a human body and a second external electronic device is worn on a human body in a state in which an electronic device is connected to communicate with each of the first external electronic device and the second external electronic device according to an embodiment of the disclosure;

FIG. 10C illustrates a case in which a second external electronic device is worn on a human body in a state in which an electronic device is connected to communicate with the second external electronic device without any communication connection with a first external electronic device according to an embodiment of the disclosure;

FIG. 11A is a diagram illustrating a case in which each of a first external electronic device and a second external electronic device is worn on a human body in a state in which a first external electronic device is not connected to communicate with an electronic device and is connected to communicate with a second external electronic device according to an embodiment of the disclosure;

FIG. 11B is a diagram illustrating a case in which a first external electronic device is not worn on a human body and a second external electronic device is worn on a human body in a state in which a first external electronic device is not connected to communicate with an electronic device and is connected to communicate with a second external electronic device according to an embodiment of the disclosure; and

FIG. 12 is a diagram illustrating a case in which a second external electronic device is worn on a human body in a state in which a second external electronic device is not connected to communicate with an electronic device and a first external electronic device according to an embodiment of the disclosure.

Throughout the drawings, like reference numerals will be understood to refer to like parts, components, and structures.

### MODE FOR CARRYING OUT THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

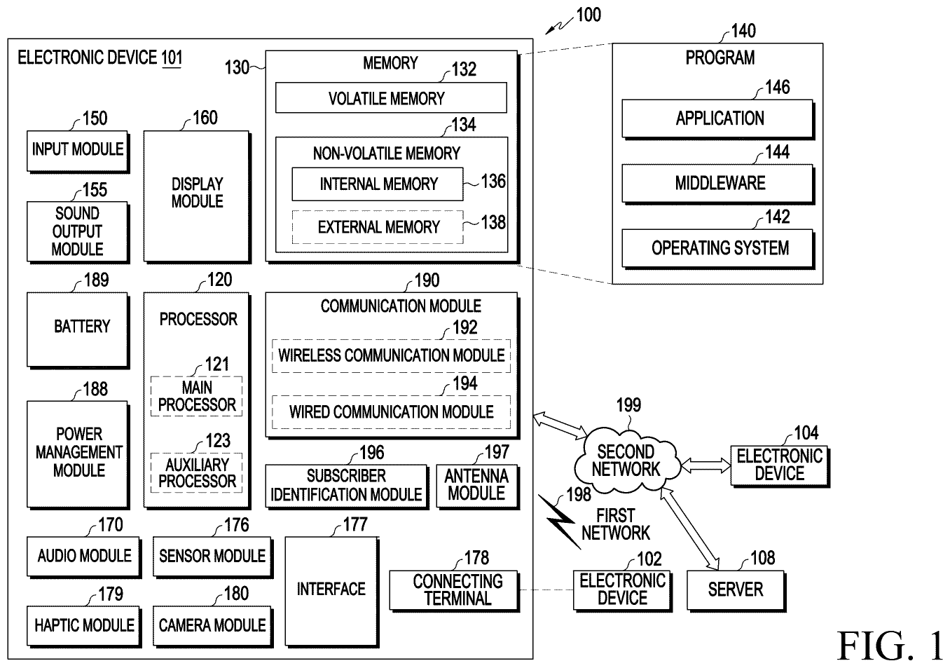

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing 1eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

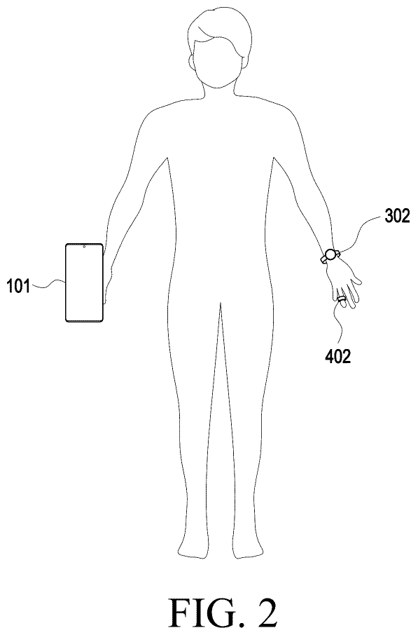

FIG. 2 is a diagram illustrating an electronic device and external electronic devices according to an embodiment of the disclosure.

Referring to FIGS. 1 and 2, the electronic device 101 according to an embodiment may communicate with at least one of other external electronic devices (for example, a first external electronic device 302 and a second external electronic device 402). The electronic device 101, the first external electronic device 302, and the second external electronic device 402 according to an embodiment may be electronic devices having different performance and battery capacities. For example, the capacity of the battery included in the first external electronic device 302 may be larger than the capacity of the battery included in the second external electronic device 402. For example, the performance of the first external electronic device 302 may be better than the performance of the second external electronic device 402. For example, the second external electronic device 402 may have the shorter duration of usage than the first external electronic device 302 due to the performance and/or the battery capacity.

The electronic device 101 according to an embodiment may be a smartphone. The first external electronic device (for example, a first wearable electronic device) 302 according to an embodiment may be a watch-type electronic device worn on a user's wrist. The second external electronic device (for example, a second wearable electronic device) 402 according to an embodiment may be a ring-type electronic device worn on a user's finger. According to an embodiment of the disclosure, the first external electronic device 302 and/or the second external electronic device 402 may be different types of electronic devices that are worn on a user's body part or that can be inserted or attached thereto. For example, the first external electronic device 302 and/or the second external electronic device 402 may include a glove-type electronic device, or a tattoo-type electronic device, or body insertion-type electronic device, and may include other types of electronic devices. According to an embodiment of the disclosure, it is obvious that the external appearance of the first external electronic device 302 or the second external electronic device 402 may be implemented in a design different from the design (or external appearance) shown in FIG. 2.

When the electronic device 101 according to an embodiment is connected to communicate with the first external electronic device 302 or connected to communicate with each of the first external electronic device 302 and the second external electronic device 402, the electronic device 101 may operate in a main (or primary) mode (or phone main mode) (hereinafter, referred to as a “first mode”). The first external electronic device 302 according to an embodiment may operate in a main (or primary) mode (or watch main mode) (hereinafter, referred to as a ‘second mode’) when the second external electronic device 402 is connected to the second external electronic device 402 while the first external electronic device 302 is not connected to the electronic device 101. When the second external electronic device 402 according to an embodiment is not connected to communicate with the electronic device 101 and is not connected to communicate with the first external electronic device 302, the second external electronic device 402 may operate in a standalone mode (hereinafter, referred to as a ‘third mode”).

The processor 120 (or at least one processor) of the electronic device 101 according to an embodiment may make a communication connection between the electronic device 101 and the first external electronic device 302 and/or a communication connection between the electronic device 101 and the second external electronic device 402 through the communication module 190.

The processor 120 according to an embodiment may operate in the first mode, based on the communication connection between the electronic device 101 and the first external electronic device 302 and/or the communication connection with the second external electronic device 402. When the connection with the first external electronic device 302 is made through communication using the communication module 190, the processor 120 according to an embodiment may receive a first sensor list (for example, a first available sensor list) (or first sensor information) indicating at least one sensor included in the first external electronic device 302 to be able to perform a sensing operation by being from the first external electronic device 302. For example, the first sensor list (or first sensor information) may include the type of each of at least one sensor included in the first external electronic device 302, identification information indicating each of at least one sensor included in the first external electronic device 302 (for example, sensor ID), and/or detailed product information of each of at least one sensor included in the first external electronic device 302.

When the connection with the second external electronic device 402 is made through communication using the communication module 190, the processor 120 according to an embodiment may receive a second sensor list (for example, a second available sensor list) indicating at least one sensor included in the second external electronic device 402 to be able to perform a sensing operation by being from the second external electronic device 402. For example, the second sensor list (or second sensor information) may include the type of each of at least one sensor included in the second external electronic device 402, identification information indicating each of at least one sensor included in the second external electronic device 402 (for example, sensor ID), and/or detailed product information of each of at least one sensor included in the second external electronic device 402. The processor 120 according to an embodiment may acquire the first sensor list of the first external electronic device 302 and the second sensor list of the second external electronic device 402 pre-stored in the memory 130. The processor 120 according to an embodiment may receive identification information (for example, a device ID or a model name) of the first external electronic device 302 (or the second external electronic device 402) from the first external electronic device 302 (or second external electronic device 402) and acquire the first sensor list (or second sensor list) of the first external electronic device 302 (or second external electronic device 402) stored in the memory 130 by using the identification information of the first external electronic device 302 (or second external electronic device 402).

The processor 120 according to an embodiment may acquire the first sensor list of the first external electronic device 302 and the second sensor list of the second external electronic device 402 from an external server (for example, the server 108 of FIG. 1). The processor 120 according to an embodiment may receive identification information (for example, the device ID or the model name) of the first external electronic device 302 (or second external electronic device 402) from the first external electronic device 302 (or second external electronic device 402) and receive the first sensor list (or second sensor list) of the first external electronic device 302 (or second external electronic device 402) from an external server by using identification information of the first external electronic device 302 (or second external electronic device 402).

The processor 120 according to an embodiment may compare the first sensor list with the second sensor list to identify at least one (duplicated) sensor which performs a similar or the same sensing function (or sensing operation).

The processor 120 according to an embodiment may receive at least one sensor value sensed by at least one sensor periodically (or at specified time intervals or in real time) from the first external electronic device 302 through the communication module 190, based on the first external electronic device 302 being worn on the human body during the connection with the first external electronic device 302 through the communication module 190. According to an embodiment of the disclosure, sensor values corresponding to a plurality of sensors, respectively, may be received, and the number of sensors corresponding to the received sensor values may not be limited. In the description of the disclosure, the case in which one sensor value (hereinafter, referred to as a “first sensor value”) sensed by one sensor (hereinafter, referred to as a “first sensor”) is received will be described as an example.

The first sensor according to an embodiment may be one of the sensors in the first sensor list of the first external electronic device 302. For example, the first sensor may be a sensor for sensing an environment around the user or sensing a biometric signal of the user of the first external electronic device 302. For example, the first sensor may be an acceleration sensor (for example, a 6-axis sensor or a 3-axis sensor), a temperature sensor, a heart rate monitoring (HRM) sensor, an air pressure sensor, a magnetic sensor, or an illuminance sensor, and other sensors.

The processor 120 according to an embodiment may identify whether the first sensor value received from the first external electronic device 302 is a valid value. The processor 120 according to an embodiment may identify that the first sensor value is a valid value when it is included in a specified sensor value range (for example, a valid sensor value range) for the first sensor, and identify that the first sensor value is not the valid value when it is not included in the valid sensor value range for the first sensor. According to an embodiment of the disclosure, when the first sensor is an acceleration sensor, the processor 120 may identify that an acceleration value is a valid value when the acceleration value sensed by the acceleration sensor is within a valid acceleration value range, and may identify that the acceleration value is not the valid value when the acceleration value is not within the valid acceleration value range. According to an embodiment of the disclosure, the valid acceleration value range may be a predetermined acceleration value range that may occur from movement in human daily life. For example, the predetermined acceleration value range may be 0 m/s² to 100 m/s² or an acceleration value range corresponding to a speed of 0 m/s to 20 m/s. According to an embodiment of the disclosure, when the first sensor is a temperature sensor, the processor 120 may identify that a temperature value is a valid value when the temperature value sensed by the temperature sensor is within a valid temperature value range, and identify that the temperature value is not the valid value when the temperature value is not within the valid temperature value range. According to an embodiment of the disclosure, the valid temperature value range may be a valid human body surface temperature range. For example, the human body surface temperature range may be 20 degrees Celsius to 40 degrees Celsius. According to an embodiment of the disclosure, when the first sensor is an HRM sensor, the processor 120 may identify that a heart rate value or breath count value sensed by the HRM sensor is a valid value when the heart rate value or the breath count value is within a valid heart rate value or breath count value range, and identify that the heart rate value or the breath count value is not the valid value when the heart rate value or the breath count value is not within the valid heart rate value or breath count value range. According to an embodiment of the disclosure, the valid heart rate value range may be 45 bpm (beats per minute) to 200 bpm, and the valid breath count value range may be 10 brpm (breaths per minute) to 40 brpm. When the first sensor includes a sensor other than the acceleration sensor, the temperature sensor, and the HRM sensor, the processor 120 according to an embodiment may identify whether another sensor value sensed by the other sensor is a valid value according to whether the sensor value is within a predetermined valid sensor value range for the other sensor, and the type of the first sensor may not be limited.

When it is identified that the first sensor value is not the valid value, the processor 120 according to an embodiment may transmit a sensor control signal (hereinafter, referred to as a “default sensor control signal”) configured by default for the second external electronic device 402 to the second external electronic device 402 through the communication module 190. The second external electronic device 402 according to an embodiment may activate at least one sensor included in the second external electronic device 402 according to the default sensor control signal, and allow each of the at least one sensor to acquire at least one sensor value sensed at its default (or normal) sensing time interval. The processor 120 according to an embodiment may receive at least one sensor value obtained through sensing at the default (or normal) sensing time interval from the second external electronic device 402 in the state where it is identified that the first sensor value is not a valid value.

When it is identified that the first sensor value is a valid value, the processor 120 according to an embodiment may identify a sensor (for example, hereinafter, referred to as a “second sensor”) of the second external electronic device 402 corresponding to the first sensor of the first external electronic device 302. The processor 120 according to an embodiment may identify the second sensor of the second external electronic device 402 capable of providing a sensor value that may replace the received first sensor value sensed by the first sensor of the first external electronic device 302. For example, when the first acceleration value sensed by the acceleration sensor from the first external electronic device 302 is a valid value, the processor 120 may identify an acceleration sensor of the second external electronic device 402 that may provide a value similar or identical to the first acceleration value (for example, overlapping value). For example, when the first temperature value sensed by the temperature sensor from the first external electronic device 302 is a valid value, the processor 120 may identify a temperature sensor of the second external electronic device 402 that may provide a value similar or identical to the first temperature value (for example, overlapping value). For example, the processor 120 may identify an HRM sensor of the second external electronic device 402 that may provide a value similar or identical to the first breath count value or a first heart rate value (for example, overlapping value) when the first breath count value or the first heart rate value sensed by the HRM sensor is a valid value from the first external electronic device 302.

When the second sensor is identified, the processor 120 according to an embodiment may transmit a sensor control signal for deactivating the second sensor or changing the sensing time interval of the second sensor of the second external electronic device 402 to a sensing time interval (hereinafter, referred to as a ‘second sensing time interval’) greater than the default (or normal) sensing time interval (hereinafter, referred to as a ‘first sensing time interval’) to the second external electronic device 402 through the communication module 190. When the second sensor is identified, the processor 120 according to an embodiment may determine whether to deactivate the second sensor or change the sensing time interval of the second sensor from the first sensing time interval to the second sensing time interval according to a predetermined reference. For example, the predetermined reference may be determined as one of various references, such as the current consumption of the second sensor and the length of the first sensing time interval of the second sensor. For example, it may be decided to deactivate the second sensor when the current consumption of the second sensor is greater than the predetermined current consumption, and change the sensing time interval from the first sensing time interval to the second sensing time interval without deactivating the second sensor when the current consumption of the second sensor is less than or equal to the predetermined current consumption. For example, it may be decided to deactivate the second sensor when the first sensing time interval of the second sensor is less than the predetermined time period, and change the sensing time interval from the first sensing time interval to the second sensing time interval without deactivating the second sensor when the first sensing time interval of the second sensor is greater than or equal to the predetermined time period The predetermined references are not limited to the above-described embodiment.

The memory 130 according to an embodiment may include one or more storage media storing instructions. The memory 130 according to an embodiment may store various pieces of data used by at least one element (for example, the processor 120 and/or the communication module 190) of the electronic device 101. The memory 130 according to an embodiment may store a program (for example, software or the program 140 of FIG. 1) and various pieces of data generated while the program is executed. The memory 130 according to an embodiment may store commands (or instructions) causing the processor 120 to execute a program (or a method or operations) for controlling an external sensor (for example, the second sensor of the second external electronic device 304) of the disclosure.

An electronic device (for example, the electronic device 101 of FIG. 1) according to an embodiment of the disclosure includes communication module 190, memory (for example, the memory 130 of FIG. 1) configured to store instructions, and at least one processor (for example, the processor 120 of FIG. 1), wherein the instructions, when executed by the at least one processor individually or collectively, may cause the electronic device to identify, based on communication between the electronic device and a first external electronic device 302 and communication between the electronic device and a second external electronic device 402 through the communication circuitry, a first sensor of the first external electronic device and a second sensor of the second external electronic device corresponding to the first sensor. The instructions, when executed by the at least one processor individually or collectively, may cause the electronic device to identify whether, when a first sensor value sensed by the first sensor is received from the first external electronic device, based on the first external electronic device being worn on a human body, the first sensor value is a valid value. The instructions, when executed by the at least one processor individually or collectively, may cause the electronic device to transmit, based on identifying that the first sensor value is the valid value, a sensor control signal for deactivating the second sensor or changing a first sensing time interval of the second sensor to a second sensing time interval greater than the first sensing time interval to the second external electronic device through the communication circuitry.

The instructions according to an embodiment of the disclosure, when executed by the at least one processor individually or collectively, may cause the electronic device to receive a second sensing value sensed by the second sensor according to the first sensing time interval, based on the first sensor value not being the valid value.

The instructions according to an embodiment of the disclosure, when executed by the at least one processor individually or collectively, may cause the electronic device to identify that the first sensor value is the valid value when the first sensor value is within a valid sensor value range for the first sensor, and identify that the first sensor value is not the valid value when the first sensor value is not within the valid sensor value range for the first sensor.

The first sensor according to an embodiment of the disclosure may include an acceleration sensor, a temperature sensor, or an HRM sensor.

The instructions according to an embodiment of the disclosure, when executed by the at least one processor individually or collectively, may cause the electronic device to, when an acceleration value sensed by the acceleration sensor is within a valid acceleration value range, identify that the acceleration value is the valid value, and when the acceleration value is not within the valid acceleration value range, identify that the acceleration value is not the valid value.

The instructions according to an embodiment of the disclosure, when executed by the at least one processor individually or collectively, may cause the electronic device to, when a temperature value sensed by the temperature sensor is within a valid temperature value range, identify that the temperature value is the valid value and, when the temperature value is not within the valid temperature value range, identify that the temperature value is not the valid value.

The instructions according to an embodiment of the disclosure, when executed by the at least one processor individually or collectively, may cause the electronic device to, when a breath count (brpm) value or heart rate (bpm) value sensed by the HRM sensor is within a valid breath count value or heart rate value range, identify that the breath count value or the heart rate value is the valid value and, when the breath count value or the heart rate value is not within the valid breath count value or heart rate value range, identify that the breath count value or the heart rate value is not the valid value.

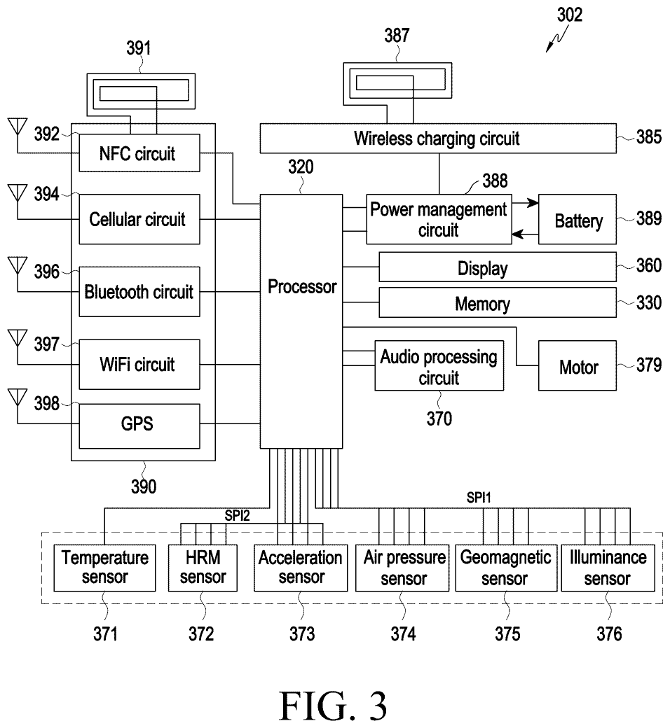

FIG. 3 is a block diagram of a first external electronic device according to an embodiment of the disclosure.

Referring to FIG. 3, a first external electronic device 302 according to an embodiment is a type of electronic device, and a watch-type wearable electronic device worn on a user's wrist is described as an example, but other forms may be possible.

The first external electronic device 302 according to an embodiment may include a processor 320, memory 330, a display 360, an audio processing circuit 370, at least one sensor 371, 372, 373, 374, 375, and 376, a motor 379, a wireless charging circuit 385, a first coil 387, a power management circuit 388, a battery 389, a communication circuitry 390, and/or a second coil 391. The first external electronic device 302 according to an embodiment is not limited thereto and may further include various elements or exclude some of the elements.

The processor 320 according to an embodiment may be at least one processor. The processor 320 according to an embodiment may be connected to communicate with at least one of the electronic device 101 and the second external electronic device 402 through the communication circuitry 390. The processor 320 according to an embodiment may operate in a predetermined mode as the electronic device 101 operates in a first mode while the connection is made through communication with the electronic device 101. For example, the processor 320 may operate in a sub mode (or a secondary mode) as the electronic device 101 operates in a main mode (or a primary mode) while the connection is made through communication with the electronic device 101. When the communication connection with the second external electronic device 402 is not made while the connection is not made with the electronic device 101 through communication, the processor 320 according to an embodiment may operate in a second mode (or the main mode (or the primary mode)).

When the connection with the electronic device 101 is made through communication, the processor 320 according to an embodiment may transmit, to the electronic device 101, a first sensor list indicating at least one sensor (for example, some or all of 371, 372, 373, 374, 375, and 376) included in the first external electronic device 302 to be able to perform the sensing operation. In the state where the connection with the electronic device 101 is made through communication and the first external electronic device 302 is worn on the human body, the processor 320 may transmit at least one sensor value sensed by at least one sensor (some or all of 371, 372, 373, 374, 375, and 376) to the electronic device 101 through the communication circuitry 390. For example, the processor 320 may transmit a first sensor value sensed by a first sensor 371, 372, 373, 374, 375, or 376 to the electronic device 101 through the communication circuitry 390.

When the communication connection is made with the second external electronic device 402 while the communication connection is not made with the electronic device 101, the processor 320 according to an embodiment may receive a second sensor list indicating at least one sensor included in the second external electronic device 402 to be able to perform the sensing operation from the second external electronic device 402 through the communication circuitry 390. The processor 320 according to an embodiment may compare the first sensor list indicating at least one sensor included in the first external electronic device 302 with the second sensor list received from the second external electronic device 402 to identify at least one (for example, duplicated) sensor performing a similar or the same sensing function (or sensing operation).

The processor 320 according to an embodiment may acquire at least one sensor value sensed by at least one sensor 371, 372, 373, 374, 375, and 376 periodically (or at predetermined time intervals or in real time), based on the first external electronic device 302 being worn on the human body. The processor 320 according to an embodiment may acquire at least one sensor value sensed by at least one sensor 371, 372, 373, 374, 375, and 376 through communication with at least one sensor 371, 372, 373, 374, 375, and 376 by using a serial peripheral interface (SPI). For example, the processor 320 may communicate with an air pressure sensor 374, a geomagnetic sensor 375, and an illuminance sensor 376 by using SPI1, and communicate with an HRM sensor 372, an acceleration sensor 373, and the illuminance sensor 376 by using SPI2. In the description of the disclosure, the case of acquiring the first sensor value from the first sensor (for example, one of 371, 372, 373, 374, 375, and 376) will be described as an example.

The processor 320 according to an embodiment may identify that a first sensor value is a valid value when the first sensor value acquired by the first sensor (one of 371, 372, 373, 374, 375, and 376) is included in a valid sensor value range for the first sensor (one of 371, 372, 373, 374, 375, and 376) and may identify that the first sensor value is not the valid value when the first sensor value is not included in the valid sensor value range for the first sensor (one of 371, 372, 373, 374, 375, and 376). According to an embodiment of the disclosure, when the first sensor is the acceleration sensor 373, the processor 320 may identify that an acceleration value is a valid value when the acceleration value sensed by the acceleration sensor 373 is included in a valid acceleration value range, and may identify that the acceleration value is not the valid value when the acceleration value is not included in the valid acceleration value range. According to an embodiment of the disclosure, the valid acceleration value range may be a predetermined acceleration value range that may occur from movement in human daily life. For example, the predetermined acceleration value range may be from about 0 m/s² to about 100 m/s² or an acceleration value range corresponding to the speed from about 0 m/s to about 20 m/s. According to an embodiment of the disclosure, when the first sensor is the temperature sensor 371, the processor 320 may identify that a temperature value is a valid value when the temperature value sensed by the temperature sensor 371 is included in a valid temperature value range, and may identify that the temperature value is not the valid value when the temperature value is not included in the valid temperature value range. According to an embodiment of the disclosure, the valid temperature value range may be a valid human body surface temperature range. For example, the human body surface temperature range may be about 20 degrees Celsius to about 40 degrees Celsius. According to an embodiment of the disclosure, when the first sensor is the HRM sensor 372, the processor 120 may identify that a heart rate value or a breath count value is a valid value when the heart rate value or breath count value sensed by the HRM sensor 372 is included in a valid heart rate value or breath count value range, and identify that the heart rate value or the breath count value is not the valid value when the heart rate value or the breath count value is not included in the valid heart rate value or breath count value range. According to an embodiment of the disclosure, the valid heart rate value range may be from about 45 bpm to about 200 bpm, and the valid breath count value range may be from about 10 brpm to about 40 brpm. When the first sensor is a sensor (for example, the air pressure sensor 374, the magnetic sensor 375, or the illuminance sensor 376) other than the acceleration sensor 373, the temperature sensor 371, and the HRM sensor 372, the processor 120 according to an embodiment may identify whether another sensor value sensed by the other sensor is valid depending on whether it is included in a valid sensor value range specified for the other sensor. According to an embodiment of the disclosure, the number of at least one sensor included in the first external electronic device 302 and the type of at least one sensor may not be limited.

When it is identified that the first sensor value is not a valid value, the processor 320 according to an embodiment may transmit a default sensor control signal for the second external electronic device 402 to the second external electronic device 402 through the communication circuitry 390. The second external electronic device 402 according to an embodiment may activate at least one sensor included in the second external electronic device 402 according to the reception of the default sensor control signal and acquire at least one sensor value sensed by the at least one sensor at its default sensing time interval. The processor 320 according to an embodiment may receive at least one sensor value acquired through sensing at a default sensing time interval from the second external electronic device 402 in the state where it is identified that the first sensor value is not the valid value.

When it is identified that the first sensor value is a valid value, the processor 320 according to an embodiment may identify the second sensor of the second external electronic device 402 corresponding to the first sensor of the first external electronic device 302. The processor 320 according to an embodiment may identify the second sensor of the second external electronic device 402 capable of providing a sensor value that may replace the received first sensor value sensed by the first sensor of the first external electronic device 302. For example, when a first acceleration value sensed by the acceleration sensor 373 of the first external electronic device 302 is a valid value, the processor 320 may identify the acceleration sensor of the second external electronic device 402 that may provide a value similar or identical to the first acceleration value (for example, overlapping value). For example, when a first temperature value sensed by the temperature sensor 372 of the first external electronic device 302 is a valid value, the processor 320 may identify the temperature sensor of the second external electronic device 402 that may provide a value similar or identical to the first temperature value (for example, overlapping values). For example, when a first breath count value or first heart rate value sensed by the HRM sensor 372 of the first external electronic device 302 is a valid value, the processor 120 may identify the HRM sensor of the second external electronic device 402 that may provide a value similar or identical to the first breath count value or the first heart rate value (for example, overlapping value).

When the second sensor of the second external electronic device 402 is identified, the processor 320 according to an embodiment may transmit a sensor control signal for deactivating the second sensor or changing the sensing time interval of the second sensor to a second sensing time interval greater than the first sensing time interval to the second external electronic device 402 through the communication circuitry 390. When the second sensor is identified, the processor 120 according to an embodiment may determine whether to deactivate the second sensor or change the sensing time interval of the second sensor from the first sensing time interval to the second sensing time interval according to a predetermined reference. According to an embodiment of the disclosure, the predetermined reference may be determined as one of various references, such as current consumption of the second sensor and the length of the first sensing time interval of the second sensor. For example, it may be decided to deactivate the second sensor when the current consumption of the second sensor is greater than the predetermined current consumption, and change the sensing time interval from the first sensing time interval to the second sensing time interval without deactivating the second sensor when the current consumption of the second sensor is less than or equal to the predetermined current consumption. For example, it may be decided to deactivate the second sensor when the first sensing time interval of the second sensor is less than the specified time period, and change the sensing time interval from the first sensing time interval to the second sensing time interval without deactivating the second sensor when the first sensing time interval of the second sensor is greater than or equal to the predetermined time period. The predetermined references are not limited to the above-described embodiment.

According to an embodiment of the disclosure, the first sensing time interval of the second sensor in the first mode in which the electronic device 101 operates as the main (or primary) and the first sensing time interval of the second sensor in the second mode in which the first external electronic device 302 operates as the main (or primary) may be different from each other. For example, since the first external electronic device (302) has less performance and/or battery capacity than the electronic device 101, the first sensing time interval of the second sensor in the second mode in which the first external electronic device 302 operates as the main (or primary) may be longer than the first sensing time interval of the second sensor in the first mode in which the electronic device 101 operates as the main (or primary).

According to an embodiment of the disclosure, the second sensing time interval of the sensor control signal transmitted to the second external electronic device 402 in the first mode in which the electronic device 101 operates as the main (or primary) and the second sensing time interval of the sensor control signal transmitted to the second external electronic device 402 in the second mode in which the first external electronic device 302 operates as the main (or primary) may be different from each other. For example, since the first external electronic device 302 has less performance and/or battery capacity than the electronic device 101, the second sensing time interval in the second mode in which the first external electronic device 302 operates as the main (or primary) may be longer than the second sensing time interval in the first mode in which the electronic device 101 operates as the main (or primary).

The memory 330 according to an embodiment may include one or more storage media storing instructions. The memory 330 according to an embodiment may store various data used by at least one element (for example, the processor 320 and/or the communication circuitry 390) of the first external electronic device 302. The memory 330 according to an embodiment may store various data generated during execution of programs including a program (for example, software or program). The memory 330 according to an embodiment may store commands (or instructions) causing the processor 320 to execute a program (or a method or operations) for controlling an external sensor (for example, the second sensor of the second external electronic device 304) of the disclosure.

The display 360 according to an embodiment may display various piece of information, based on the control of the processor 320. For example, the display 360 may display sensing information using at least one sensor value sensed by at least one sensor (for example, some or all of 371, 372, 373, 374, 375, and 376), based on the control of the processor 320. The display 360 according to an embodiment may display various pieces of information generated while executing a program (or methods or operations) for controlling an external sensor (for example, the second sensor of the second external electronic device 304), based on the control of the processor 320. According to an embodiment of the disclosure, the display 360 may be implemented in the form of a touch screen. When the display 360 is implemented together with an input module in the form of a touch screen, various piece of information generated according to a user's touch action may be displayed. In an embodiment of the disclosure, the display 360 may be configured by at least one of a liquid crystal display (LCD), a thin film transistor LCD (TFT-LCD), an organic light emitting diode (OLED), LED, active matrix OLED (AMOLED), a micro LED, a mini LED, a flexible display, and a three-dimensional display. Further, some of the displays may be configured in a transparent or light-transmitting type so that the outside can be seen through them. The displays may be implemented in a transparent display type including transparent OLED (TOLED).

The audio processing circuit 370 according to an embodiment may input or output a sound and may include, for example, at least one of an audio codec, a microphone (MIC), a receiver, an earphone output (EAR_L), or a speaker. The audio processing circuit 370 according to an embodiment may output an audio signal corresponding to sensing information using at least one sensor value sensed by at least one sensor (some or all of 371, 372, 373, 374, 375, and 376). based on the control of the processor 320. The audio processing circuit 370 according to an embodiment may output various audio signals generated while performing a program (or methods or operations) for controlling an external sensor (for example, the second sensor of the second external electronic device 304), based on the control of the processor 320.

At least one sensor (for example, 371, 372, 373, 374, 375 and 376) according to an embodiment may include one or more sensors for sensing a surrounding environment of the user of the first external electronic device 302 or sensing a biometric signal of the user of the first external electronic device 302. At least one sensor (for example, 371, 372, 373, 374, 375 and 376) according to an embodiment may include a temperature sensor 371, an HRM sensor 372, an acceleration sensor 373, an atmospheric pressure sensor 374, a magnetic sensor 374, and/or an illuminance sensor 376. The temperature sensor 371 according to an embodiment may measure a body temperature while the first external electronic device 302 is worn on the human body, and output the measured body temperature sensing signal. The HRM sensor 372 according to an embodiment may measure a breath count and/or a heart rate while the first external electronic device 302 is worn on the human body, and output the measured breath count value and/or heart rate value. The acceleration sensor 372 according to an embodiment may include a three-axis or six-axis acceleration sensor, and may output a three-axis acceleration sensor value or a six-axis acceleration sensor value while the first external electronic device 302 is worn on the human body. The air pressure sensor 374 according to an embodiment may measure air pressure and output the measured air pressure sensor value. The geomagnetic sensor 375 according to an embodiment may measure the Earth's magnetic field and output the measured geomagnetic sensor value. The illuminance sensor 376 according to an embodiment may measure external illuminance and output the measured illuminance sensor value. At least one sensor (for example, 371, 372, 373, 374, 375 and 376) according to an embodiment may further include another sensor for sensing the surrounding environment of the user or sensing the biometric signal of the user of the first external electronic device 302, such as a pressure sensor (not shown), a proximity sensor (not shown), an altitude sensor (not shown), and a humidity sensor (not shown), in addition to the temperature sensor 371, the HRM sensor 372, the acceleration sensor 373, the air pressure sensor 374, the magnetic sensor 374, and/or the illumination sensor 376. The number and type of at least one sensor included in the first external electronic device 302 may not be limited.

The motor 379 according to an embodiment may vibrate or perform a haptic vibration operation, based on a motor control signal (or a motor control waveform) from the processor 320. The motor 379 according to an embodiment may perform a vibration operation for representing various pieces of information generated while performing a program (or methods or operations) for controlling an external sensor (for example, the second sensor of the second external electronic device 304), based on the control of the processor 320.

The wireless charging circuit 385 according to an embodiment may receive a wireless charging current received from an external power source (not shown) through the first coil 387 (for example, a wireless charging antenna) and charge the battery 389.

The power management circuit 388 according to an embodiment may manage power supplied to the first external electronic device 302 by using the battery 389. According to an embodiment of the disclosure, the power management circuit 388 may be implemented as at least a part of a power management integrated circuit (PMIC).

The battery 389 according to an embodiment may supply power to at least one element of the first external electronic device 302. According to an embodiment of the disclosure, the battery 389 may include a rechargeable secondary battery or a fuel cell.

The communication circuitry 390 according to an embodiment may support establishment of a wireless communication channel with each of the electronic device 101 and/or the second external electronic device 402, and performance of communication through the established communication channel. The communication circuitry 390 according to an embodiment may support establishment of a wireless communication channel with other electronic devices (for example, the server 108 of FIG. 1) other than the electronic device 101 and/or the second external electronic device 402 and performance of communication through the established communication channel. The communication circuitry 390 according to an embodiment may include one or more communication processors or communication circuits supporting wireless communication. According to an embodiment of the disclosure, the communication circuitry 390 may include a near field communication (NFC) circuit 392, a cellular circuit 394, a Bluetooth circuit 396, a Wi-Fi circuit 397, and/or a GPS circuit 398. The NFC circuit 392, the cellular circuit 394, the Bluetooth circuit 396, the Wi-Fi circuit 397, and/or the GPS circuit 398 according to an embodiment may be integrated into one component (for example, a single chip), or may be implemented as a plurality of separate components (for example, multiple chips).

The second coil 391 according to an embodiment may serve as an antenna for transmitting a magnetic-based signal including a short-range communication signal or payment data.

An electronic device (for example, the first external electronic device 302 of FIG. 3) according to an embodiment of the disclosure includes communication circuitry 390, memory 330 configured to store instructions, and at least one processor 320, wherein the instructions, when executed by the at least one processor individually or collectively, cause the electronic device to identify a first sensor of the electronic device and a second sensor of a second external electronic device corresponding to the first sensor when the electronic device is not connected to communicate with the first external electronic device 302 and is connected to communicate with the second external electronic device 401 through the communication circuitry. The instructions, when executed by the at least one processor individually or collectively, may cause the electronic device to identify whether, in case that a first sensor value sensed by the first sensor is acquired based on identifying the electronic device being worn on a human body, the first sensor value is a valid value. The instructions, when executed by the at least one processor individually or collectively, may cause the electronic device to transmit, based on the first sensor value being the valid value, a sensor control signal for deactivating the second sensor or changing a sensing period of the second sensor to a second sensing time interval greater than the first sensing time interval to the second external electronic device 402 through the communication circuitry. The second sensing time interval may be different from a sensing time interval corresponding to a sensor control signal received from the first external electronic device 302 when the second external electronic device 402 is connected to the first external electronic device 302.

The instructions, when executed by the at least one processor individually or collectively, may cause the electronic device to identify that the first sensor value is the valid value when the first sensor value is within a valid sensor value range for the first sensor, and identify that the first sensor value is not the valid value when the first sensor value is not within the valid sensor value range for the first sensor.

The first sensor according to an embodiment may include an acceleration sensor, a temperature sensor, or an HRM sensor.

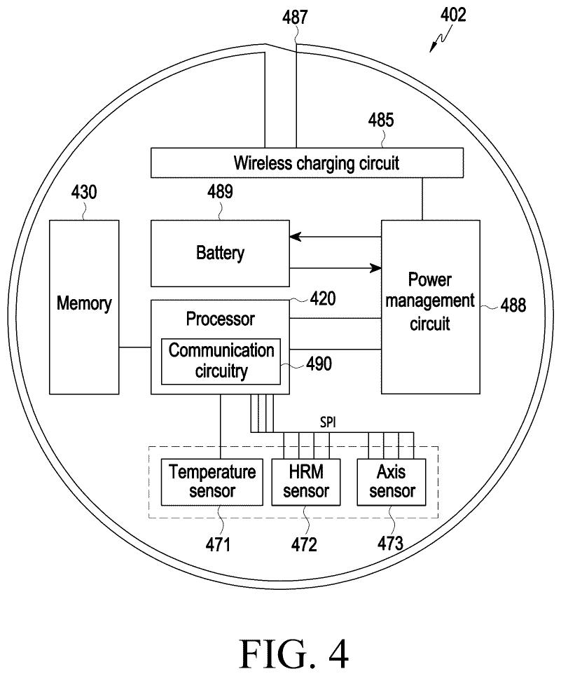

FIG. 4 is a block diagram of a second external electronic device according to an embodiment of the disclosure.

Referring to FIG. 4, a second external electronic device 402 according to an embodiment is a type of electronic device and a ring-type wearable electronic device that can be worn on a user's finger is described as an example, but other types may be possible.

The second external electronic device 402 according to an embodiment may include a processor 420, memory 430, at least one sensor 471, 472 and 473, a wireless charging circuit 485, a coil 487, a power management circuit 488, a battery 489, and/or communication circuitry 490. The second external electronic device 402 according to an embodiment is not limited thereto and may further include various elements or exclude some of the elements.

The processor 420 according to an embodiment may be connected to at least one of the electronic device 101 or the first external electronic device 302 through communication via the communication circuitry 490. The processor 420 according to an embodiment may be implemented integrally including the communication circuitry 490.

When the connection with the electronic device 101 (or the first external electronic device 302) is made through communication, the processor 420 according to an embodiment may transmit a second sensor list indicating at least one sensor (for example, some or all of 471, 472, and 473) included in the second external electronic device 402 to be able to perform a sensing operation to the electronic device 101 (or the first external electronic device 302) through the communication circuitry 490. When the connection with the electronic device 101 (or the first external electronic device 302) is made through communication, the processor 420 according to an embodiment may transmit human body wearing information indicating whether the second external electronic device 402 is worn the human body to the electronic device 101 (or the first external electronic device 302).

The processor 420 according to an embodiment may be connected to the electronic device 101 (or the first external electronic device 302) through communication, and may receive a default sensor control signal from the electronic device 101 (or the first external electronic device 302) while the second external electronic device 402 is worn on the human body. The processor 420 according to an embodiment may acquire at least one sensor value sensed by at least one sensor (some or all of 471, 472, and 473) through communication with at least one sensor (some or all of 471, 472, and 473) by using a serial peripheral interface (SPI). In the description of the disclosure, the case of obtaining a first sensor value from one of the at least one sensor 471, 472, and 473 (for example, the second sensor) will be described as an example. When the default sensor control signal is received, the processor 420 according to an embodiment may control the second sensor to perform sensing at a first sensing time interval.

The processor 420 according to an embodiment may be connected to the electronic device 101 (or the first external electronic device 302) through communication, and may receive a sensor control signal for deactivating the second sensor corresponding to the first sensor of the second external electronic device 402 or changing a sensing time interval of the second sensor to a second sensing time interval greater than the first sensing time interval from the electronic device 101 (or the first external electronic device 302) while the second external electronic device 402 is worn on the human body. When receiving the sensor control signal for deactivating the second sensor or changing the sensing time interval of the second sensor to the second sensing time interval greater than the first sensing time interval from the electronic device 101 (or the first external electronic device 302), the processor 420 according to an embodiment may deactivate the second sensor or transmit a second sensor value sensed by the second sensor, based on the second sensing time interval, to the electronic device 101 (or the first external electronic device 302) through the communication circuitry 490.

The processor 420 according to an embodiment may perform the operation of a third mode when the communication connection with an external electronic device (e.g., the electronic device 101 or the first external electronic device 302) is not made.

The processor 420 according to an embodiment may acquire sensor values by using at least one sensor (for example, some or all of 471, 472, and 473) in the third mode. The processor 420 according to an embodiment may store the acquired sensor values in the memory 430. According to an embodiment of the disclosure, the processor 420 may accumulate and store sensor values in the memory 430 without transmitting the sensor values to the electronic device 101 and the first external electronic device 302 in the third mode. As time passes, the remaining storage capacity of the memory 430 may decrease.

The processor 420 according to an embodiment may identify whether the storage capacity of the memory 430 is in a full state. The processor 420 according to an embodiment may store the acquired sensor values in the memory 430 when the storage capacity of the memory 430 is not in the full state.

When the storage capacity of the memory 430 is in the full state, the processor 420 according to an embodiment may secure the storage space of the memory 430 by identifying priorities of the sensor values stored in the memory 430 and deleting sensor values having a low priority according to a predetermined reference. The processor 420 according to an embodiment may identify whether each of the sensor values stored in the memory 430 is a sensor value (for example, normal recording information) in a normal range or a sensor value (for example, abnormal recording information) in an abnormal range, and determine a priority of the sensor value in the abnormal range as a higher priority than the sensor value in the normal range. The processor 420 according to an embodiment may determine that the sensor value in the abnormal range having a high sensor priority among the sensor values in the abnormal range has a higher priority than the sensor value in the abnormal range having a low sensor priority. The processor 420 according to an embodiment may determine that the sensor value in the abnormal range having a high sensor priority among the sensor values in the abnormal range has a higher priority than the sensor value in the abnormal range having a low sensor priority. The processor 420 according to an embodiment may determine that a sensor value in the abnormal range having a recent update order among the sensor values in the abnormal range has a priority higher than the sensor value in the abnormal range having an old update order. For example, the sensor value in the abnormal range having the first priority may be a sensor value that is acquired from the highest priority sensor and is most recently acquired among the sensor values in the abnormal range. The sensor value in the abnormal range having a second priority may be a sensor value that is acquired from the highest priority sensor but is not most recently acquired among the sensor values in the abnormal range. The sensor value in the abnormal range having a third priority may be a sensor value that is acquired from a second priority sensor and is most recently acquired among the sensor values in the abnormal range. The sensor value in the abnormal range having a fourth priority may be a sensor value that is acquired from a second priority sensor but is not most recently acquired among sensor values in the abnormal range. The processor 420 according to an embodiment may identify the priority of the sensor value according to a predetermined reference, such as identifying the first to fourth priorities whenever the sensor value is updated, and store the sensor values up to the priority within a range allowed by the capacity of the memory 430. When the communication connection with an external electronic device (for example, the electronic device 101 or the first external electronic device 302) is made in the third mode and thus the third mode ends, the processor 420 according to an embodiment may provide sensor values in the abnormal range stored in the memory 430 according to the priority to an external electronic device (for example, the electronic device 101 or the first external electronic device 302).

The memory 430 according to an embodiment may include one or more storage media storing instructions. The memory 430 according to an embodiment may store various data used by at least one element (for example, the processor 420 and/or the communication circuitry 490) of the second external electronic device 402. The memory 430 according to an embodiment may store various data generated during execution of programs including a program (for example, software or program). The memory 430 according to an embodiment may store instructions that cause the processor 420 to execute a program (or method) for performing operations according to the third mode of the disclosure.

At least one sensor (for example, 471, 472, and 473) according to an embodiment may include a sensor for sensing a biometric signal of the user of the second external electronic device 402. At least one sensor (for example, 471, 472, and 473) according to an embodiment may include a temperature sensor 471, an HRM sensor 472, or an acceleration sensor 473. The temperature sensor 471 according to an embodiment may measure a body temperature while the second external electronic device 302 is worn on the human body and may output the measured body temperature sensing signal. The HRM sensor 472 according to an embodiment may measure the breath count and/or a heart rate while the second external electronic device 302 is worn on the human body, and output the measured breath count value and/or heart rate value. The acceleration sensor 472 according to an embodiment may include a three-axis or six-axis acceleration sensor, and may output a three-axis acceleration sensor value or a six-axis acceleration sensor value while the second external electronic device 402 is worn on the human body. At least one sensor (for example, 471, 472, and 473) according to an embodiment may further include another sensor that senses the biometric signal of the user of the second external electronic device 402 in addition to the temperature sensor 471, the HRM sensor 472, or the acceleration sensor 473. The number and type of at least one sensor included in the second external electronic device 402 may not be limited.

The wireless charging circuit 485 according to an embodiment may charge the battery 489 by receiving the wireless charging current received from the external power source (not shown) through the coil 487 (for example, a wireless charging antenna).

The power management circuit 488 according to an embodiment may manage power supplied to the second external electronic device 402 by using the battery 489. According to an embodiment of the disclosure, the power management circuit 488 may include a power management integrated circuit (PMIC).

The battery 489 according to an embodiment may supply power to at least one element of the second external electronic device 402. According to an embodiment of the disclosure, the battery 489 may include a rechargeable secondary battery or a fuel cell. According to an embodiment of the disclosure, the battery 489 may be a battery having a charging capacity less than that of the battery 389 of the first external electronic device 302.

The communication circuitry 490 according to an embodiment may include a Bluetooth communication circuitry (for example, a Bluetooth low energy (BLE) communication circuit). The communication circuitry 490 according to an embodiment may be implemented integrally with the processor 420. The communication circuitry 490 according to an embodiment may support establishment of a BLE communication channel with each of the external electronic device 101 or the first external electronic device 302 and performance of communication through the established BLE communication channel.

The electronic device (for example, 402 of FIG. 4) according to an embodiment of the disclosure may include communication circuitry 490, at least one sensor 471, 472, 473, memory 430 for storing instructions, and at least one processor 420. The instructions according to an embodiment may cause, when individually or collectively executed by the at least one processor 420, the electronic device (e.g., second external electronic device 402) to store sensor values sensed by the at least one sensor in a storage area of the memory 430 when the electronic device (e.g., second external electronic device 402) is not connected to communicate with the first external electronic device (e.g., electronic device 101) and the second external electronic device (e.g., first electronic device 302) through the communication circuitry 490. The instructions may cause, when individually or collectively executed by the at least one processor 420, the electronic device (e.g., second external electronic device 402) to identify priories of sensor values stored in the storage area when the storage area is in a full state. The instructions may cause, when individually or collectively executed by the at least one processor 420, the electronic device (e.g., second external electronic device 402) to identify sensor values in a normal range having priorities lower than a predetermined priority reference among the stored sensor values and sensor values in an abnormal range having priorities higher than the predetermined priority reference, delete the sensor values in the normal range, and secure a storage space of the memory 430.

The instructions according to an embodiment may cause, when individually or collectively executed by the at least one processor 420, the electronic device 402 to, when the electronic device 402 is connected to communicate with the first external electronic device 101 and the second external electronic device 302 through the communication circuitry, transmit the sensor values in the abnormal range stored in the memory to the first external electronic device 101 or the second external electronic device 302.

A sensing time interval of at least one sensor 471, 472, and 473 according to an embodiment may be a time interval different from or longer than a second sensing time interval of a sensor control signal transmitted to the electronic device 402 in a first mode in which the first external electronic device 101 operates as the main (or primary). A sensing time interval of at least one sensor 471, 472, and 473 according to an embodiment may be a time interval different from or longer than a second sensing time interval of a sensor control signal transmitted to the electronic device 402 in a second mode in which the second external electronic device 302 operates as the main (or primary).

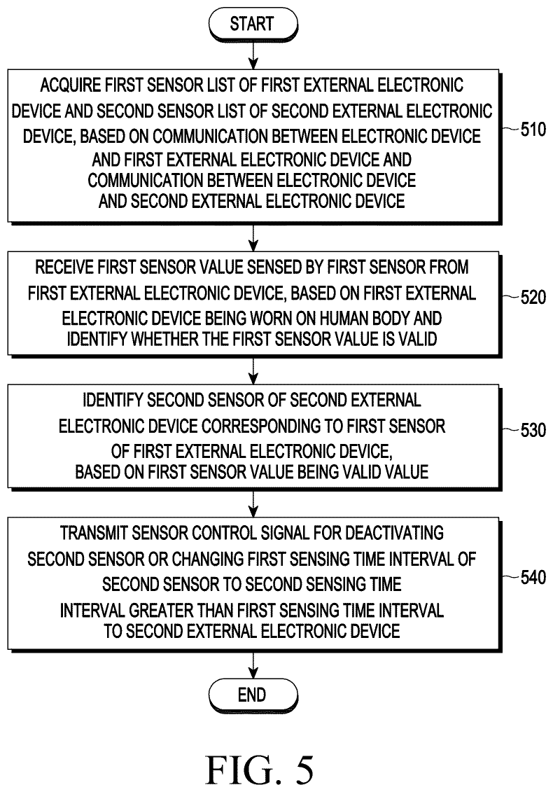

FIG. 5 is a flowchart illustrating an operation in which an electronic device controls an external sensor according to an embodiment of the disclosure.

Referring to FIG. 5, the processor 120 of the electronic device 101 according to an embodiment may perform at least one of operations 510 to 540.

In operation 510, the processor 120 according to an embodiment may acquire a first sensor list (for example, a first available sensor list) of the first external electronic device 302 and a second sensor list (for example, a second available sensor list) of the second external electronic device 402 through communication between the electronic device 101 and the first external electronic device 302 and communication between the electronic device 101 and the second external electronic device 402. For example, the first sensor list may indicate at least one sensor included in the first external electronic device 302 to be able to perform a sensing operation. For example, the second sensor list may indicate at least one sensor included in the second external electronic device 402 to be able to perform a sensing operation. The processor 120 according to an embodiment may acquire the first sensor list and the second sensor list through communication between the electronic device 101 and the first external electronic device 302 and communication between the electronic device 101 and the second external electronic device 402. The processor 120 according to an embodiment may acquire the first sensor list of the first external electronic device 302 and the second sensor list of the second external electronic device 402 pre-stored in the memory 130. The processor 120 according to an embodiment may compare the first sensor list with the second sensor list to identify (for example, duplicated) the first sensor of the first external electronic device 302 that performs similar or identical sensing functions (or sensing operation) and the second sensor of the second external electronic device 402 corresponding to the first sensor.

In operation 520, the processor 120 according to an embodiment may receive a first sensor value sensed by the first sensor (periodically or at predetermined time intervals or in real time) from the first external electronic device 302, based on the first external electronic device 302 being worn on the human body, and identify whether the first sensor value is a valid value. The first sensor according to an embodiment is one of the sensors in the first sensor list, and may be one of sensors for sensing a surrounding environment of the user of the first external electronic device 302 or sensing a biometric signal of the user of the first external electronic device 302. For example, the first sensor may include an acceleration sensor (for example, a 6-axis sensor or a 3-axis sensor), a temperature sensor, and a heart rate monitoring (HRM) sensor, and further include other sensors. The processor 120 according to an embodiment may identify that the first sensor value is a valid value when the first sensor value is included in a valid sensor value range for the first sensor, and identify that the first sensor value is not the valid value when the first sensor value is not included in the valid sensor value range for the first sensor. According to an embodiment of the disclosure, when the first sensor is the acceleration sensor 373, the processor 120 may identify that an acceleration value is a valid value when the acceleration value sensed by the acceleration sensor 373 is included in a valid acceleration value range, and may identify that the acceleration value is not the valid value when the acceleration value is not included in the valid acceleration value range. According to an embodiment of the disclosure, the valid acceleration value range may be a predetermined acceleration value range that may occur from movement in human daily life. For example, the predetermined acceleration value range may be 0 m/s² to 100 m/s² or an acceleration value range corresponding to a speed of 0 m/s to 20 m/s.

According to an embodiment of the disclosure, when the first sensor is the temperature sensor 371, the processor 120 may identify that a temperature value is a valid value when the temperature value sensed by the temperature sensor 371 is included in a valid temperature value range, and may identify that the temperature value is not the valid value when the temperature value is not included in the valid temperature value range. According to an embodiment of the disclosure, the valid temperature value range may be a valid human body surface temperature range. For example, the human body surface temperature range may be 20 degrees Celsius to 40 degrees Celsius. According to an embodiment of the disclosure, when the first sensor is the HRM sensor 372, the processor 120 may identify that a heart rate value or a breath count value is a valid value when the heart rate value or breath count value sensed by the HRM sensor is included in a valid heart rate value or breath count value range, and identify that the heart rate value or the breath count value is not the valid value when the heart rate value or the breath count value is not included in the valid heart rate value or breath count value range. According to an embodiment of the disclosure, the valid heart rate value range may be 45 bpm to 200 bpm, and the valid breath count value range may be 10 brpm to 40 brpm. When the first sensor includes a sensor other than the acceleration sensor 373, the temperature sensor 371, and the HRM sensor 372, the processor 120 according to an embodiment may identify whether another sensor value is valid according to whether the sensor value sensed by the other sensor is within a valid sensor value range specified for the other sensor, and the type of the first sensor may not be limited.

In operation 530, the processor 120 according to an embodiment may identify the second sensor of the second external electronic device 402 corresponding to the first sensor of the first external electronic device 302, based on the first sensor value being the valid value. The processor 120 according to an embodiment may identify the second sensor of the second external electronic device 402 capable of providing a sensor value that may replace the received first sensor value sensed by the first sensor of the first external electronic device 302. For example, when the first acceleration value sensed by the acceleration sensor 373 from the first external electronic device 302 is a valid value, the processor 120 may identify the acceleration sensor 473 of the second external electronic device 402 that may provide a value similar or identical to the first acceleration value (for example, overlapping value). For example, when the first temperature value sensed by the temperature sensor 371 from the first external electronic device 302 is a valid value, the processor 120 may identify the temperature sensor 471 of the second external electronic device 402 that may provide a value similar or identical to the first temperature value (for example, overlapping value). For example, when the first breath count value or first heart rate value sensed by the HRM sensor 372 from the first external electronic device 302 is a valid value, the processor 120 may identify the HRM sensor 472 of the second external electronic device 402 that may provide a value similar or identical to the first breath count value or the first heart rate value (for example, overlapping value).

In operation 540, when the second sensor is identified, the processor 120 according to an embodiment may transmit a sensor control signal for deactivating the second sensor or changing a sensing time interval of the second sensor of the second external electronic device 402 to a second sensing time interval greater than a first sensing time interval to the second external electronic device 402 through the communication module 190. When the second sensor is identified, the processor 120 according to an embodiment may determine whether to deactivate the second sensor or change the sensing time interval of the second sensor from the first sensing time interval to the second sensing time interval according to a predetermined reference. For example, the predetermined reference may be determined as one of various references, such as the current consumption of the second sensor or the length of the first sensing time interval of the second sensor. For example, it may be decided to deactivate the second sensor when the current consumption of the second sensor is greater than the predetermined current consumption, and change the sensing time interval from the first sensing time interval to the second sensing time interval without deactivating the second sensor when the current consumption of the second sensor is less than or equal to the predetermined current consumption. For example, it may be determined to deactivate the second sensor when the first sensing time interval of the second sensor is less than the predetermined time period, and change the sensing time interval from the first sensing time interval to the second sensing time interval without deactivating the second sensor when the first sensing time interval of the second sensor is greater than or equal to the predetermined time period. The predetermined references are not limited to the above-described embodiment.

A method of controlling an external sensor by an electronic device (for example, the electronic device 101 of FIG. 1) according to an embodiment of the disclosure may include an operation of, based on communication between the electronic device and a first external electronic device (for example, the first external electronic device 302 of FIG. 2) and communication between the electronic device and a second external electronic device (for example, the second external electronic device 402 of FIG. 2) through communication circuitry (for example, the communication module 190 of FIG. 1), identifying a first sensor of the first external electronic device and a second sensor of the second external electronic device corresponding to the first sensor. The method may include an operation of, when a first sensor value sensed by the first sensor is received from the first external electronic device, based on the first external electronic device being worn on a human body, identifying whether the first sensor value is a valid value. The method may include an operation of, based on the first sensor value being identified as the valid value, transmitting a sensor control signal for deactivating the second sensor or changing a first sensing time interval of the second sensor to a second sensing time interval greater than the first sensing time interval to the second external electronic device through the communication circuitry.

The method according to an embodiment may further include an operation of receiving a second sensing values sensed by the second sensor according to a first sensing time interval, based on the first sensor value not being the valid value.

The method according to an embodiment may further include an operation of, when the first sensor value is within a valid sensor value range for the first sensor, identifying that the first sensor value is the valid value and an operation of, when the first sensor value is not within the valid sensor value range for the first sensor, identify that the first sensor value is not the valid value.

In the method according to an embodiment of the disclosure, the first sensor may include an acceleration sensor, a temperature sensor, or an HRM sensor.

The method according to an embodiment may further include an operation of, when an acceleration value sensed by the acceleration sensor is within a valid acceleration value range, identifying that the acceleration value is the valid value and, when the acceleration value is not within the valid acceleration value range, identifying that the acceleration value is not the valid value.

The method according to an embodiment may further include an operation of, when a temperature value sensed by the temperature sensor is within a valid temperature value range, identifying that the temperature value is the valid value and, when the temperature value is not within the valid temperature value range, identifying that the temperature value is not the valid value.

The method according to an embodiment may further include an operation of, when a breath count value or heart rate value sensed by the HRM sensor is within a valid breath count value or heart rate value range, identifying that the breath count value or the heart rate value is the valid value and, when the breath count value or the heart rate value is not within the valid breath count value or heart rate value range, identifying that the breath count value or the heart rate value is not the valid value.

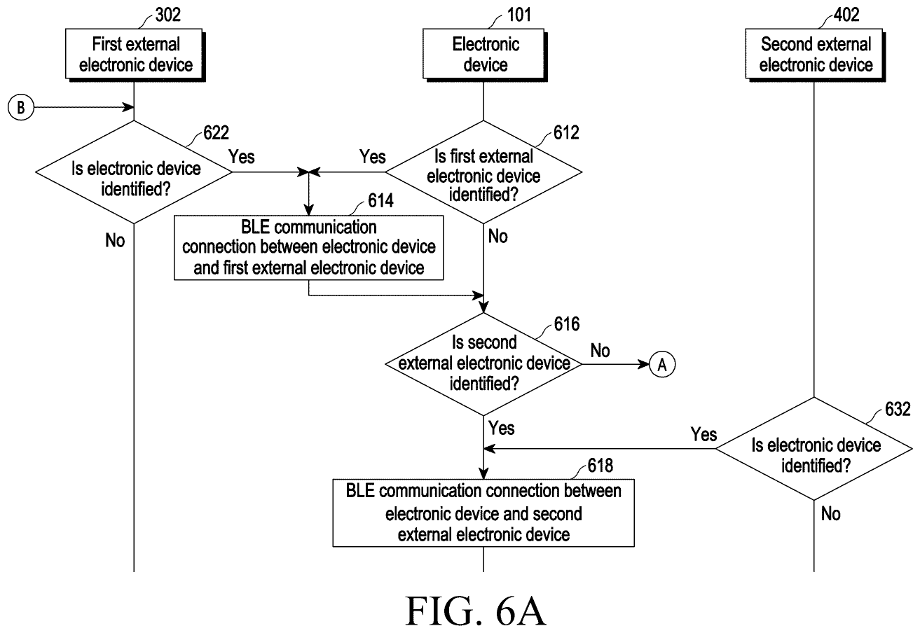

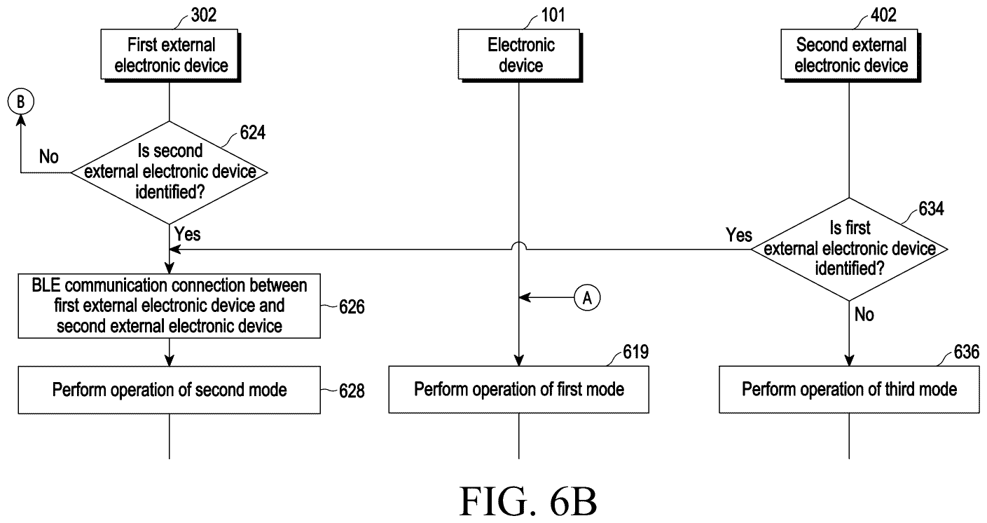

FIG. 6A is a flowchart illustrating an operation in which an electronic device, a first external electronic device, and a second external electronic device enter a first mode, a second mode, and a third mode according to an embodiment of the disclosure.

FIG. 6B is a flowchart illustrating an operation following after FIG. 6A according to an embodiment of the disclosure.

Referring to FIGS. 6A and 6B, the electronic device 101, the first external electronic device 302, and the second external electronic device 402 according to an embodiment may perform at least one of operations 612, 614, 616, 618, 619, 622, 624, 626, 628, 632, 634, and 636.

In operation 612, the processor 120 of the electronic device 101 according to an embodiment may search for surrounding external electronic devices through BLE communication and, when the first external electronic device 302 exists, identify the first external electronic device 302.

In operation 614, the processor 120 of the electronic device 101 according to an embodiment may connect BLE communication between the electronic device 101 and the first external electronic device 302, based on the first external electronic device 302 being identified.

In operation 616, the processor 120 of the electronic device 101 according to an embodiment may determine whether the second external electronic device 402 is identified.

In operation 618, the processor 120 of the electronic device 101 according to an embodiment may perform BLE communication between the electronic device 101 and the second external electronic device 402 when the second external electronic device 402 is identified.

In operation 619, the processor 120 of the electronic device 101 according to an embodiment may perform the operation of the first mode (for example, the main mode (or primary mode) of the electronic device), based on BLE communication between the electronic device 101, and the first external electronic device 302 and the second external electronic device 402, and BLE communication between the electronic device 101 and the second external electronic device 402 being connected.

In operation 622, the processor 320 of the first external electronic device 302 according to an embodiment may search for surrounding external electronic devices through BLE communication and, when the electronic device 101 exists, identify the electronic device 101. When the electronic device 101 is identified, the processor 320 of the first external electronic device 302 according to an embodiment may connect BLE communication between the electronic device 101 and the first external electronic device 302 as in operation 614.

In operation 624, the processor 320 of the first external electronic device 302 according to an embodiment may determine whether the second external electronic device 402 is identified.

In operation 626, when the second external electronic device 402 is identified, the processor 320 of the first external electronic device 302 according to an embodiment may perform BLE communication between the first external electronic device 302 and the second external electronic device 492.

In operation 628, the processor 320 of the first external electronic device 302 according to an embodiment may perform the operation of the second mode (for example, the main mode (or the primary mode) of the first external electronic device), based on the BLE communication being connected with the second external electronic device 402 while the first external electronic device 302 is not connected to the electronic device 101.

In operation 632, the processor 420 of the second external electronic device 402 according to an embodiment may search for surrounding external electronic devices through BLE communication and determine whether the electronic device 101 is identified. When the electronic device 101 is identified, the processor 420 of the second external electronic device 402 according to an embodiment may connect BLE communication between the electronic device 101 and the second external electronic device 402 as in operation 618.

In operation 634, when the electronic device 101 is not identified, the processor 420 of the second external electronic device 402 according to an embodiment may determine whether the first external electronic device 302 is identified. When the first external electronic device 302 is identified, the processor 420 of the second external electronic device 402 according to an embodiment may perform BLE communication between the first external electronic device 302 and the second external electronic device 492 as in operation 626.

In operation 636, the processor 420 of the second external electronic device 402 according to an embodiment may perform the operation in the third mode (for example, the standalone mode of the second external electronic device), based on the second external electronic device 402 being not connected to the electronic device 101 and the first external electronic device 302.

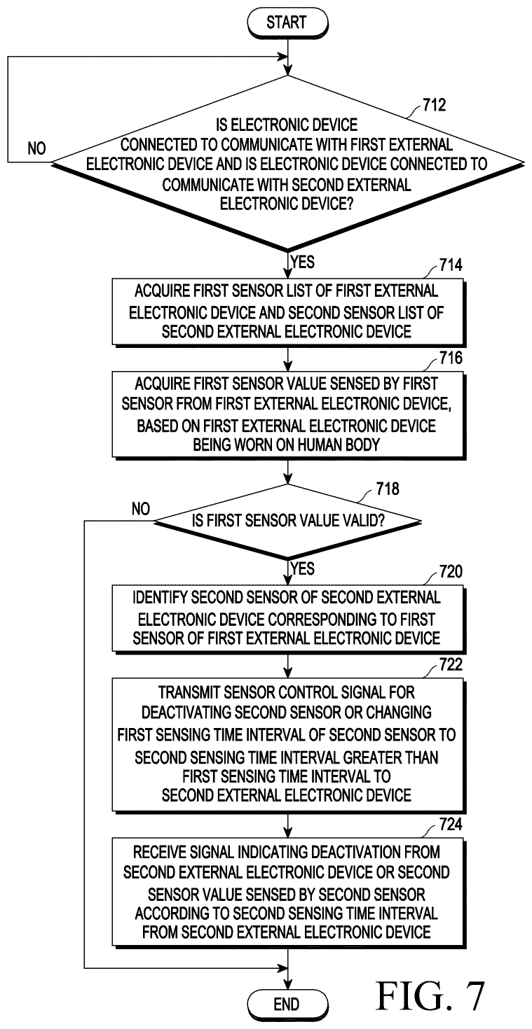

FIG. 7 is a flowchart illustrating an operation of controlling a sensor of a second external electronic device while an electronic device is connected to a first external electronic device and a second external electronic device according to an embodiment of the disclosure.

Referring to FIG. 7, the processor 120 of the electronic device 101 according to an embodiment may perform at least one of operations 712 to 724.

In operation 712, the processor 120 according to an embodiment may identify a communication connection between the electronic device 101 and the first external electronic device 302 and a communication connection between the electronic device 101 and the second external electronic device 402.

In operation 714, the processor 120 according to an embodiment may acquire a first sensor list (for example, a first available sensor list) of the first external electronic device 302 and a second sensor list (for example, a second available sensor list) of the second external electronic device 402 in a communication connection with each of the first external electronic device 302 and the second external electronic device 402. For example, the first sensor list may indicate at least one sensor included in the first external electronic device 302 to be able to perform a sensing operation. For example, the second sensor list may indicate at least one sensor included in the second external electronic device 402 to be able to perform a sensing operation. The processor 120 according to an embodiment may acquire the first sensor list and the second sensor list through communication between the electronic device 101 and the first external electronic device 302 and communication between the electronic device 101 and the second external electronic device 402. The processor 120 according to an embodiment may acquire a first sensor list of the first external electronic device 302 and a second sensor list of the second external electronic device 402 stored in the memory 130. The processor 120 according to an embodiment may compare the first sensor list with the second sensor list to identify (for example, duplicated) the first sensor of the first external electronic device 302 that performs similar or identical sensing functions (or sensing operations) and the second sensor of the second external electronic device 402 corresponding to the first sensor.

In operation 716, the processor 120 according to an embodiment may acquire a first sensor value sensed by the first sensor from the first external electronic device 302, based on the first external electronic device 302 being worn the human body. The processor 120 according to an embodiment may receive human body wearing information indicating that the first external electronic device 302 is worn on the human body from the first external electronic device 302 to identify whether the first external electronic device 302 is worn on the human body. The processor 120 according to an embodiment may receive a first sensor value sensed periodically, at predetermined time intervals, or in real time by the first sensor included in the first external electronic device 302 while the first external electronic device 302 is worn on the human body. The first sensor according to an embodiment is one of the sensors in the first sensor list, and may be one of sensors for sensing a surrounding environment of the user of the first external electronic device 302 or sensing a biometric signal of the user of the first external electronic device 302. For example, the first sensor may include an acceleration sensor (for example, a 6-axis sensor or a 3-axis sensor), a temperature sensor, and a heart rate monitoring (HRM) sensor, and further include other sensors.

In operation 718, the processor 120 according to an embodiment of the disclosure may identify whether the first sensor value is valid. The processor 120 according to an embodiment may identify that the first sensor value is a valid value when the first sensor value is included in a valid sensor value range for the first sensor, and identify that the first sensor value is not the valid value when the first sensor value is not included in the valid sensor value range for the first sensor. According to an embodiment of the disclosure, when the first sensor is the acceleration sensor 373, the processor 120 may identify that an acceleration value is a valid value when the acceleration value sensed by the acceleration sensor 373 is included in a valid acceleration value range, and may identify that the acceleration value is not the valid value when the acceleration value is not included in the valid acceleration value range. According to an embodiment of the disclosure, the valid acceleration value range may be a predetermined acceleration value range that may occur from movement in human daily life. For example, the predetermined acceleration value range may be from about 0 m/s² to about 100 m/s² or an acceleration value range corresponding to the speed from about 0 m/s to about 20 m/s. According to an embodiment of the disclosure, when the first sensor is the temperature sensor 371, the processor 120 may identify that a temperature value is a valid value when the temperature value sensed by the temperature sensor 371 is included in a valid temperature value range, and identify that the temperature value is not the valid value when the temperature value is not included in the valid temperature value range. According to an embodiment of the disclosure, the valid temperature value range may be a valid human body surface temperature range. For example, the human body surface temperature range may be about 20 degrees Celsius to about 40 degrees Celsius. According to an embodiment of the disclosure, when the first sensor is the HRM sensor 372, the processor 120 may identify that a heart rate value or a breath count value is a valid value when the heart rate value or breath count value sensed by the HRM sensor is included in a valid heart rate value or breath count value range, and identify that the heart rate value or the breath count value is not the valid value when the heart rate value or the breath count value is not included in the valid heart rate value or breath count value range. According to an embodiment of the disclosure, the valid heart rate value range may be about 45 bpm to 200 bpm, and the valid breath count value range may be about 10 brpm to 40 brpm. When the first sensor includes a sensor other than the acceleration sensor 373, the temperature sensor 371, and the HRM sensor 372, the processor 120 according to an embodiment may identify whether another sensor value is valid according to whether the sensor value sensed by the other sensor is within a valid sensor value range specified for the other sensor, and the type of the first sensor may not be limited.

In operation 720, the processor 120 according to an embodiment may identify the second sensor of the second external electronic device 402 corresponding to the first sensor of the first external electronic device 302, based on the first sensor value being the valid value. The processor 120 according to an embodiment may identify the second sensor of the second external electronic device 402 capable of providing a sensor value that may replace the received first sensor value sensed by the first sensor of the first external electronic device 302. For example, when the first acceleration value sensed by the acceleration sensor 373 from the first external electronic device 302 is a valid value, the processor 120 may identify the acceleration sensor 473 of the second external electronic device 402 that may provide a value similar or identical to the first acceleration value (for example, overlapping value). For example, when the first temperature value sensed by the temperature sensor 371 from the first external electronic device 302 is a valid value, the processor 120 may identify the temperature sensor 471 of the second external electronic device 402 that may provide a value similar or identical to the first temperature value (for example, overlapping value). For example, when the first breath count value or first heart rate value sensed by the HRM sensor 372 from the first external electronic device 302 is a valid value, the processor 120 may identify the HRM sensor 472 of the second external electronic device 402 that may provide a value similar or identical to the first breath count value or the first heart rate value (for example, overlapping value).

In operation 722, the processor 120 according to an embodiment may transmit a sensor control signal for deactivating the second sensor of the second external electronic device 402 or changing a sensing time interval of the second sensor to a second sensing time interval greater than a first sensing time interval to the second external electronic device 402 through the communication module 190. When the second sensor is identified, the processor 120 according to an embodiment may determine whether to deactivate the second sensor or change the sensing time interval of the second sensor from the first sensing time interval to the second sensing time interval according to a predetermined reference. For example, the predetermined reference may be determined as one of various references, such as the current consumption of the second sensor and the length of the first sensing time interval of the second sensor. For example, it may be determined to deactivate the second sensor when the current consumption of the second sensor is greater than the predetermined current consumption, and change the sensing time interval from the first sensing time interval to the second sensing time interval without deactivating the second sensor when the current consumption of the second sensor is less than or equal to the predetermined current consumption. For example, it may be decided to deactivate the second sensor when the first sensing time interval of the second sensor is less than the specified time period, and change the sensing time interval from the first sensing time interval to the second sensing time interval without deactivating the second sensor when the first sensing time interval of the second sensor is greater than or equal to the predetermined time period. The predetermined references are not limited to the above-described embodiment.

In operation 724, the processor 120 according to an embodiment may receive a signal indicating that the second sensor is deactivated or a second sensor value sensed according to a second sensing time interval by the second sensor from the second external electronic device 402.

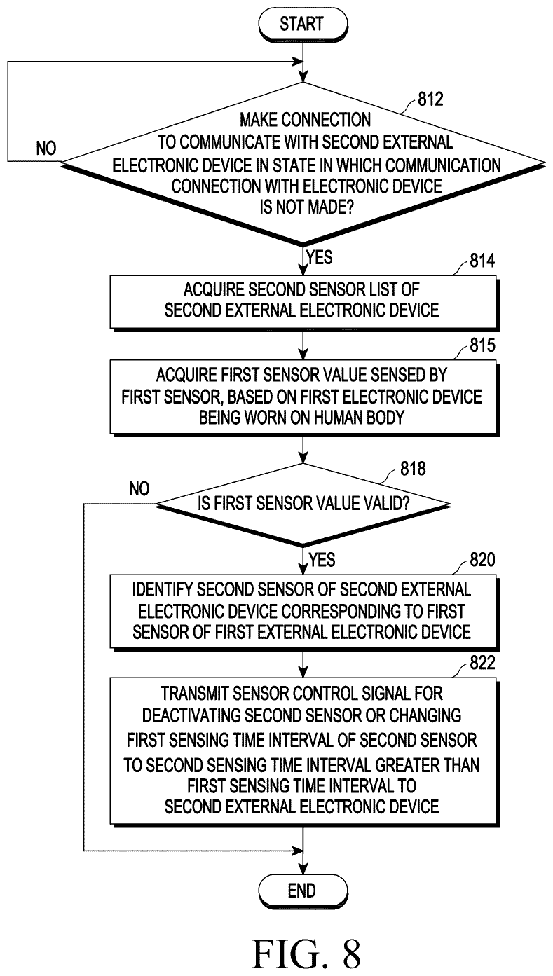

FIG. 8 is a flowchart illustrating an operation of controlling a sensor of a second external electronic device while a first external electronic device is not connected to an electronic device but is connected to a second external electronic device according to an embodiment of the disclosure.

Referring to FIG. 8, the processor 320 of the first external electronic device 302 according to an embodiment may perform at least one of operations 812 to 822.

In operation 812, the processor 320 according to an embodiment may identify whether the processor 320 is connected to communicate with the second external electronic device 402 in the state in which the connection is not made to communicate with the electronic device 101.

In operation 814, when the connection is made to communicate with the second external electronic device 402 in the state in which the connection is not made to communicate with the electronic device 101, the processor 320 according to an embodiment may acquire the second sensor list of the second external electronic device 402. The second sensor list according to an embodiment may indicate at least one sensor included in the second external electronic device 402 to be able to perform the sensing operation. According to an embodiment of the disclosure, the processor 320 may receive and acquire the second sensor list from the second external electronic device 402 through the communication circuitry 390 (for example, the Bluetooth communication circuit 396) or acquire the second sensor list pre-stored in the memory 330. The processor 320 according to an embodiment may identify at least one (for example, duplicated) sensor that performs a similar or identical sensing function (or sensing operation) by comparing the first sensor list indicating at least one sensor included in the first external electronic device 302 with the second sensor list.

In operation 815, the processor 320 according to an embodiment may acquire a first sensor value sensed by the first sensor, based on the first external electronic device 302 being worn on the human body. The first sensor according to an embodiment is one of the sensors in the first sensor list, and may be one of sensors for sensing a surrounding environment of the user of the first external electronic device 302 or sensing a biometric signal of the user of the first external electronic device 302. For example, the first sensor may be one of at least one of the sensors 371, 372, 373, 374, 375, and 376 included in the first external electronic device 302.

In operation 818, the processor 320 according to an embodiment may identify whether the first sensor value is valid. The processor 320 according to an embodiment may identify that the first sensor value is a valid value when the first sensor value is included in a valid sensor value range for the first sensor, and identify that the first sensor value is not the valid value when the first sensor value is not included in the valid sensor value range for the first sensor. According to an embodiment of the disclosure, when the first sensor is the acceleration sensor 373, the processor 320 may identify that an acceleration value is a valid value when the acceleration value sensed by the acceleration sensor 373 is included in a valid acceleration value range, and may identify that the acceleration value is not the valid value when the acceleration value is not included in the valid acceleration value range. According to an embodiment of the disclosure, the valid acceleration value range may be a predetermined acceleration value range that may occur from movement in human daily life. For example, the predetermined acceleration value range may be from about 0 m/s² to about 100 m/s² or an acceleration value range corresponding to the speed from about 0 m/s to about 20 m/s. According to an embodiment of the disclosure, when the first sensor is the temperature sensor 371, the processor 320 may identify that a temperature value is a valid value when the temperature value sensed by the temperature sensor 371 is included a valid temperature value range, and identify that the temperature value is not the valid value when the temperature value is not included in the valid temperature value range. According to an embodiment of the disclosure, the valid temperature value range may be a valid human body surface temperature range. For example, the human body surface temperature range may be about 20 degrees Celsius to about 40 degrees Celsius. According to an embodiment of the disclosure, when the first sensor is the HRM sensor 372, the processor 120 may identify that a heart rate value or a breath count value is a valid value when the heart rate value or breath count value sensed by the HRM sensor is included in a valid heart rate value or breath count value range, and identify that the heart rate value or the breath count value is not the valid value when the heart rate value or the breath count value is not included in the valid heart rate value or breath count value range. According to an embodiment of the disclosure, the valid heart rate value range may be from about 45 bpm to about 200 bpm, and the valid breath count value range may be from about 10 brpm to about 40 brpm. When the first sensor includes a sensor other than the acceleration sensor 373, the temperature sensor 371, and the HRM sensor 372, the processor 320 according to an embodiment may identify whether another sensor value is valid according to whether the sensor value sensed by the other sensor is within a valid sensor value range specified for the other sensor, and the type of the first sensor may not be limited.

In operation 820, the processor 320 according to an embodiment may identify the second sensor of the second external electronic device 402 corresponding to the first sensor of the first external electronic device 302, based on the first sensor value being the valid value. The processor 320 according to an embodiment may identify the second sensor of the second external electronic device 402 capable of providing a sensor value that may replace the received first sensor value sensed by the first sensor of the first external electronic device 302. For example, when the first acceleration value sensed by the acceleration sensor 373 from the first external electronic device 302 is a valid value, the processor 320 may identify the acceleration sensor 473 of the second external electronic device 402 that may provide a value similar or identical to the first acceleration value (for example, overlapping value). For example, when the first temperature value sensed by the temperature sensor 371 from the first external electronic device 302 is a valid value, the processor 320 may identify the temperature sensor 471 of the second external electronic device 402 that may provide a value similar or identical to the first temperature value (for example, overlapping value). For example, when the first breath count value or first heart rate value sensed by the HRM sensor 372 from the first external electronic device 302 is a valid value, the processor 320 may identify the HRM sensor 472 of the second external electronic device 402 that may provide a value similar or identical to the first breath count value or the first heart rate value (for example, overlapping value).

In operation 822, the processor 320 according to an embodiment may transmit a sensor control signal for deactivating the second sensor of the second external electronic device 402 or changing a sensing time interval of the second sensor to a second sensing time interval greater than a first sensing time interval to the second external electronic device 402 through the communication circuitry 390. When the second sensor is identified, the processor 320 according to an embodiment may determine whether to deactivate the second sensor or change the sensing time interval of the second sensor from the first sensing time interval to the second sensing time interval according to a predetermined reference. For example, the predetermined reference may be determined as one of various references, such as the current consumption of the second sensor and the length of the first sensing time interval of the second sensor. For example, it may be decided to deactivate the second sensor when the current consumption of the second sensor is greater than the predetermined current consumption, and change the sensing time interval from the first sensing time interval to the second sensing time interval without deactivating the second sensor when the current consumption of the second sensor is less than or equal to the predetermined current consumption. For example, it may be decided to deactivate the second sensor when the first sensing time interval of the second sensor is less than the specified time period, and change the sensing time interval from the first sensing time interval to the second sensing time interval without deactivating the second sensor when the first sensing time interval of the second sensor is greater than or equal to the predetermined time period. The predetermined references are not limited to the above-described embodiment.

A method of controlling an external sensor by an electronic device (for example, the first external electronic device 302 of FIG. 1) according to an embodiment of the disclosure may include an operation of, when the electronic device is not connected to communicate with a first external electronic device 101 and is connected to communicate with a second external electronic device 402 through communication circuitry (for example, the communication circuitry 390 of FIG. 3), identifying a first sensor of the electronic device and a second sensor of the second external electronic device 402 corresponding to the first sensor. The method may include an operation of, when a first sensor value sensed by the first sensor is acquired based on the electronic device being worn on a human body, identifying whether the first sensor value is a valid value. The method may include an operation of, based on the first sensor value being the valid value, transmitting a sensor control signal for deactivating the second sensor or changing a sensing period of the second sensor to a second sensing time interval greater than the first sensing time interval to the second external electronic device 402 through communication circuitry. The second sensing time interval may be different from a sensing time interval corresponding to a sensor control signal received from the first external electronic device (e.g., electronic device 101) when the second external electronic device 402 is connected to the first external electronic device 101.

The method according to an embodiment may further include an operation of, when the first sensor value is within a predetermined valid sensor value range for the first sensor, identify that the first sensor value is the valid value, and when the first sensor value is not within the predetermined valid sensor value range for the first sensor, identify that the first sensor value is not the valid value.

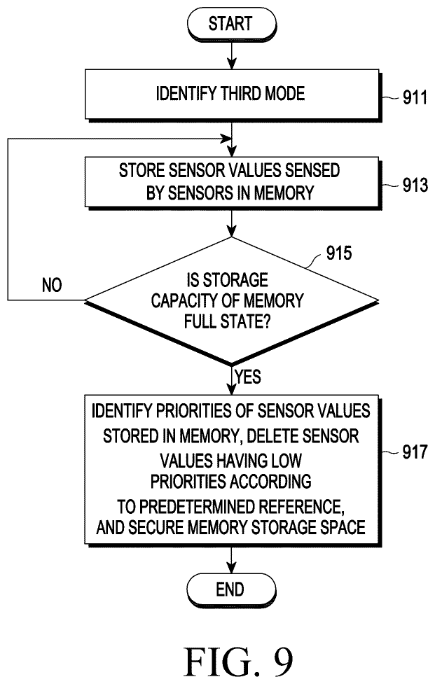

FIG. 9 is a flowchart illustrating an operation in a state in which a second external electronic device is not connected to an electronic device and is not connected to a first external electronic device according to an embodiment of the Referring to FIG. 9, the processor 420 of the second external electronic device 402 according to an embodiment may perform at least one of operations 911 to 917.

In operation 911, the processor 420 according to an embodiment may identify a third mode (for example, a standalone mode). According to an embodiment of the disclosure, the third mode may be the state in which the second external electronic device 402 is not connected to communicate with the electronic device 101 and is not connected to communicate with the first external electronic device 302.

In operation 913, the processor 420 according to an embodiment may store sensor values sensed by the sensors 471, 472, and 473 in the memory 430 in the third mode. According to an embodiment of the disclosure, the processor 420 may accumulate and store sensor values in the memory 430 without transmitting the sensor values to the electronic device 101 and the first external electronic device 302 in the third mode. As time passes, the remaining storage capacity of the memory 430 may decrease.

In operation 915, the processor 420 according to an embodiment may identify whether the storage capacity of the memory 430 is in a full state. When the storage capacity of the memory 430 is not in the full state, the processor 420 according to an embodiment may return to operation 913 and store sensed sensor values of the next period in the memory 430.

In operation 917, the processor 420 according to an embodiment may secure the storage space of the memory 430 by identifying priorities of the sensor values stored in the memory 430 and deleting sensor values having a low priority according to a predetermined reference. The processor 420 according to an embodiment may identify whether each of the sensor values stored in the memory 430 is a sensor value (for example, normal recording information) in a normal range or a sensor value (for example, abnormal recording information) in an abnormal range, and determine the priority of the sensor value in the abnormal range as a higher priority than the sensor value in the normal range. The processor 420 according to an embodiment may determine that the sensor value in the abnormal range having a high sensor priority among the sensor values in the abnormal range has a higher priority than the sensor value in the abnormal range having a low sensor priority. The processor 420 according to an embodiment may determine that the sensor value in the abnormal range having a high sensor priority among the sensor values in the abnormal range has a higher priority than the sensor value in the abnormal range having a low sensor priority. The processor 420 according to an embodiment may determine that a sensor value in the abnormal range having a recent update order among the sensor values in the abnormal range has a priority higher than the sensor value in the abnormal range having an old update order. For example, the sensor value in the abnormal range having the first priority may be a sensor value that is acquired from the highest priority sensor and is most recently acquired among the sensor values in the abnormal range. The sensor value in the abnormal range having a second priority may be a sensor value that is acquired from the highest priority sensor but is not most recently acquired among the sensor values in the abnormal range. The sensor value in the abnormal range having a third priority may be a sensor value that is acquired from a second priority sensor and is most recently acquired among the sensor values in the abnormal range. The sensor value in the abnormal range having a fourth priority may be a sensor value that is acquired from a second priority sensor but is not most recently acquired among sensor values in the abnormal range. The processor 420 according to an embodiment may identify the priority of the sensor value according to a predetermined reference, such as identifying the first to fourth priorities whenever the sensor value is updated, and store the sensor values up to the priority within a range allowed by the capacity of the memory 430. When the communication connection with an external electronic device (for example, the electronic device 101 or the first external electronic device 302) is made in the third mode and thus the third mode ends, the processor 420 according to an embodiment may provide sensor values in the abnormal range stored in the memory 430 according to the priority to an external electronic device (for example, the electronic device 101 or the first external electronic device 302).

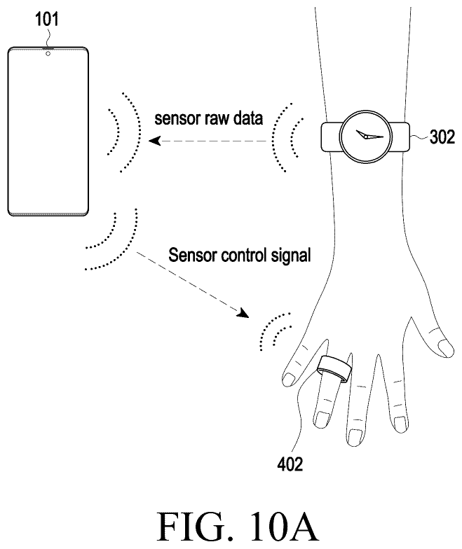

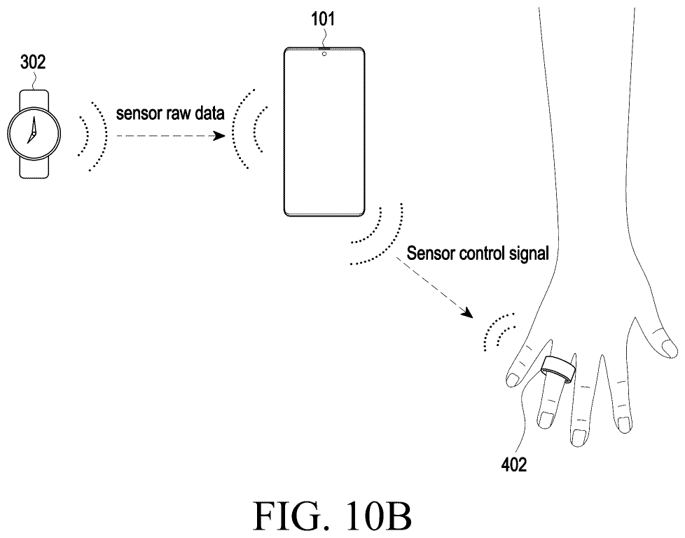

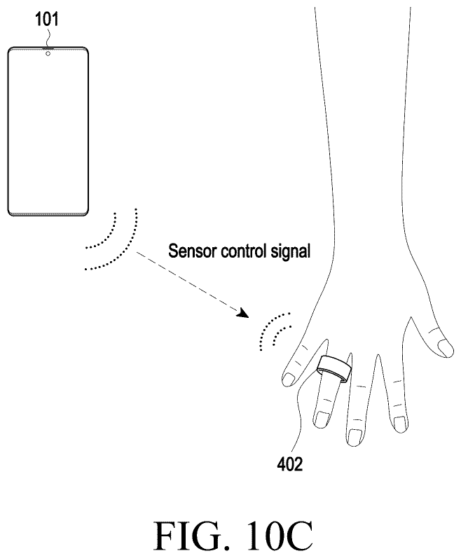

FIGS. 10A, 10B, and 10C are diagrams illustrating an electronic device operating in a first mode according to various embodiments of the disclosure.

FIG. 10A is a diagram illustrating a case in which each of a first external electronic device and a second external electronic device is worn on a human body in a state in which an electronic device is connected to communicate with each of the first external electronic device and the second external electronic device according to an embodiment of the disclosure.

Referring to FIG. 10A, the processor 120 of the electronic device 101 according to an embodiment may receive at least one sensor value (for example, sensor raw data) sensed by at least one sensor (for example, the temperature sensor 371, the HRM sensor 372, or the acceleration sensor 373) of the first external electronic device 302 in the state in which the BLE communication connection is made with each of the first external electronic device 302 and the second external electronic device 402 and each of the first external electronic device 302 and the second external electronic device 402 is worn on the human body. At least one sensor value sensed in the state in which the first external electronic device 302 according to an embodiment is worn on the human body may be included within a predetermined valid sensor value range.

The processor 120 of the electronic device 101 according to an embodiment may identify a second sensor of the second external electronic device 402 corresponding to the first sensor of the first external electronic device 302, based on at least one sensor value received from the first external electronic device 302 being the valid value included in the predetermined valid sensor value range.

The processor 120 according to an embodiment may identify the second sensor of the second external electronic device 402 capable of providing a sensor value that may replace the received first sensor value sensed by the first sensor of the first external electronic device 302. For example, when the first acceleration value sensed by the acceleration sensor 373 from the first external electronic device 302 is a valid value, the processor 120 may identify the acceleration sensor 473 of the second external electronic device 402 that may provide a value similar or identical to the first acceleration value (for example, overlapping value). For example, when the first temperature value sensed by the temperature sensor 371 from the first external electronic device 302 is a valid value, the processor 120 may identify the temperature sensor 471 of the second external electronic device 402 that may provide a value similar or identical to the first temperature value (for example, overlapping value). For example, when the first breath count value or first heart rate value sensed by the HRM sensor 372 from the first external electronic device 302 is a valid value, the processor 120 may identify the HRM sensor 472 of the second external electronic device 402 that may provide a value similar or identical to the first breath count value or the first heart rate value (for example, overlapping value).

When the second sensor is identified, the processor 120 according to an embodiment may transmit a sensor control signal for deactivating the second sensor or changing a sensing time interval of the second sensor of the second external electronic device 402 to a second sensing time interval greater than a first sensing time interval to the second external electronic device 402 through the communication module 190.

FIG. 10B is a diagram illustrating a case in which a first external electronic device is not worn on a human body and a second external electronic device is worn on the human body in a state in which an electronic device according to an embodiment is connected to communicate with each of the first external electronic device and the second external electronic device.

Referring to FIG. 10B, the processor 120 of the electronic device 101 according to an embodiment may receive at least one sensor value (for example, sensor raw data) sensed by at least one sensor (for example, the temperature sensor 371, the HRM sensor 372, or the acceleration sensor 373) of the first external electronic device 302 in the state in which the BLE communication connection is made with each of the first external electronic device 302 and the second external electronic device 402, the first external electronic device 302 is not worn on the human body, and the second external electronic device 402 is worn on the human body. At least one sensor value sensed in the state in which the first external electronic device 302 according to an embodiment is not worn on the human body may not be included in a predetermined valid sensor value range.

The processor 120 of the electronic device 101 according to an embodiment may transmit a default sensor control signal to the second external electronic device 402 through the communication module 190, based on the at least one sensor value received from the first external electronic device 302 being not the valid value included in the predetermined valid sensor value range. The second external electronic device 402 according to an embodiment may activate at least one sensor included in the second external electronic device 402 according to the default sensor control signal being received, and allow each of the at least one sensor to acquire at least one sensor value sensed at its general (or normal or default) sensing time interval.

FIG. 10C illustrates a case in which a second external electronic device is worn on a human body in a state in which an electronic device is connected to communicate with the second external electronic device without any communication connection with a first external electronic device.

Referring to FIG. 10C, the processor 120 of the electronic device 101 according to an embodiment may transmit a default sensor control signal to the second external electronic device 402 through the communication module 190 in the state in which the BLE communication connection is made with the second external electronic device 402 without any communication connection with the first external electronic device and the second external electronic device 402 is worn on the human body. The second external electronic device 402 according to an embodiment may activate at least one sensor included in the second external electronic device 402 according to the default sensor control signal being received, and allow each of the at least one sensor to acquire at least one sensor value sensed at its general (or normal or default) sensing time interval.

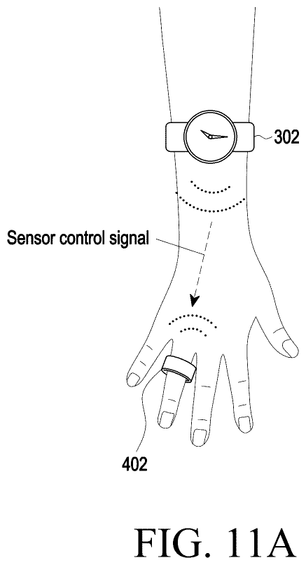

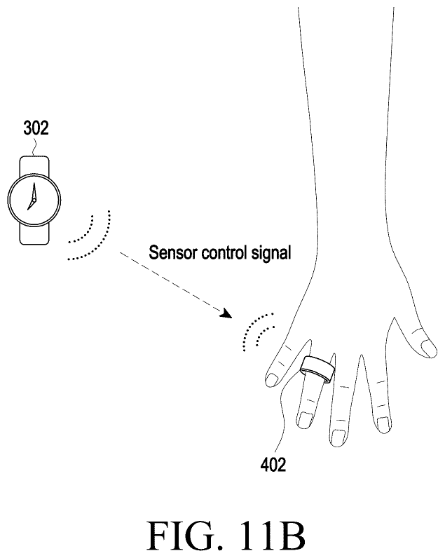

FIGS. 11A and 11B are diagrams illustrating a first external electronic device operating in a second mode according to various embodiments of the FIG. 11A is a diagram illustrating a case in which each of a first external electronic device and a second external electronic device is worn on a human body in a state in which the first external electronic device is not connected to communicate with an electronic device and is connected to communicate with the second external electronic device according to an embodiment of the disclosure.

Referring to FIG. 11A, when the first external electronic device 302 is not connected to communicate with the electronic device 101 but is connected to perform BLE communication with the second external electronic device 402, and each of the first external electronic device 302 and the second external electronic device 402 is worn on a human body, at least one sensor value (for example, sensor raw data) sensed by at least one sensor (for example, the temperature sensor 371, the HRM sensor 372, or the acceleration sensor 373) of the first external electronic device 302 may be included in a predetermined valid sensor value range.

The processor 320 of the first external electronic device 302 according to an embodiment may identify the second sensor of the second external electronic device 402 corresponding to the first sensor of the first external electronic device 302, based on the at least one sensor value sensed by the first external electronic device 302 being the valid value included in the predetermined valid sensor value range.

The processor 320 of the first external electronic device 302 according to an embodiment may identify the second sensor of the second external electronic device 402 capable of providing a sensor value that may replace the first sensor value sensed by the first sensor of the first external electronic device 302. For example, the processor 320 of the first external electronic device 302 may identify the acceleration sensor 473 of the second external electronic device 402 that may provide a value similar or identical to the first acceleration value (for example, overlapping value) when the first acceleration value sensed by the acceleration sensor 373 is a valid value. For example, the processor 320 of the first external electronic device 302 may identify the temperature sensor 471 of the second external electronic device 402 that may provide a value similar or identical to the first temperature value (for example, overlapping value) when the first temperature value sensed by the temperature sensor 371 is a valid value. For example, the processor 320 of the first external electronic device 302 may identify the HRM sensor 472 of the second external electronic device 402 that may provide a value similar or identical to the first breath count value or the first heart rate value (for example, overlapping value) when the first breath count value or first heart rate value sensed by the HRM sensor 372 is a valid value.

When the second sensor of the second external electronic device 402 is identified, the processor 320 of the first external electronic device 302 according to an embodiment may transmit a sensor control signal for deactivating the second sensor or changing the sensing time interval of the second sensor to the second sensing time interval greater than the first sensing time interval to the second external electronic device 402 through BLE communication.

FIG. 11B is a diagram illustrating a case in which a first external electronic device is not worn on a human body and a second external electronic device is worn on the human body in a state in which the first external electronic device is not connected to communicate with an electronic device and is connected to communicate with the second external electronic device according to an embodiment of the disclosure.

Referring to FIG. 11B, the processor 320 of the electronic device (e.g., first external electronic device 302) according to an embodiment may acquire at least one sensor value (for example, sensor raw data) sensed by at least one sensor (for example, the temperature sensor 371, the HRM sensor 372, or the acceleration sensor 373) in the state in which the first external electronic device 302 is not connected to communicate with the electronic device 101 but is connected to communicate with the second external electronic device 402, the first external electronic device 302 is not worn on the human body, and the second external electronic device 402 is worn on a human body. At least one sensor value sensed in the state in which the first external electronic device 302 according to an embodiment is not worn on the human body may not be included in a predetermined valid sensor value range.

The processor 320 of the first external electronic device 302 according to an embodiment may transmit a default sensor control signal to the second external electronic device 402 through the communication circuitry 390, based on at least one sensed sensor value not being the valid value included in the predetermined valid sensor value range. The second external electronic device 402 according to an embodiment may activate at least one sensor included in the second external electronic device 402 according to the default sensor control signal being received, and allow each of the at least one sensor to acquire at least one sensor value sensed at its general (or normal or default) sensing time interval.

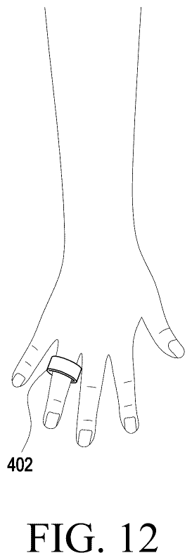

FIG. 12 is a diagram illustrating a case in which a second external electronic device is worn on a human body in a state in which a second external electronic device is not connected to communicate with an electronic device and a first external electronic device according to an embodiment of the disclosure.

Referring to FIG. 12, the processor 420 of the second external electronic device 402 according to an embodiment may operate in the third mode in the state in which the second external electronic device is not connected to communicate with the electronic device 101 and the first external electronic device 302 and is not won on the human body.

The processor 420 of the second external electronic device 402 according to an embodiment may store sensor values sensed by the sensors 471, 472, and 473 in the memory 430 in the third mode. According to an embodiment of the disclosure, the processor 420 may accumulate and store sensor values in the memory 430 without transmitting the sensor values to the electronic device 101 and the first external electronic device 302 in the third mode. As time passes, the remaining storage capacity of the memory 430 may decrease. The processor 420 according to an embodiment may identify whether the storage capacity of the memory 430 is in a full state. The processor 420 according to an embodiment may store sensed sensor values of a next period in the memory 430 when the storage capacity of the memory 430 is not in the full state. When the storage capacity of the memory 430 is in the full state, the processor 420 according to an embodiment may secure the storage space of the memory 430 by identifying priorities of the sensor values stored in the memory 430 and deleting sensor values having a low priority according to a predetermined reference. The processor 420 according to an embodiment may identify whether each of the sensor values stored in the memory 430 is a sensor value (for example, normal recording information) in a normal range or a sensor value (for example, abnormal recording information) in an abnormal range, and determine the priority of the sensor value in the abnormal range as a higher priority than the sensor value in the normal range. The processor 420 according to an embodiment may determine that the sensor value in the abnormal range having a high sensor priority among the sensor values in the abnormal range has a higher priority than the sensor value in the abnormal range having a low sensor priority. The processor 420 according to an embodiment may determine that the sensor value in the abnormal range having a high sensor priority among the sensor values in the abnormal range has a higher priority than the sensor value in the abnormal range having a low sensor priority. The processor 420 according to an embodiment may determine that a sensor value in the abnormal range having a recent update order among the sensor values in the abnormal range has a priority higher than the sensor value in the abnormal range having an old update order. For example, the sensor value in the abnormal range having the first priority may be a sensor value that is acquired from the highest priority sensor and is most recently acquired among the sensor values in the abnormal range. The sensor value in the abnormal range having a second priority may be a sensor value that is acquired from the highest priority sensor but is not most recently acquired among the sensor values in the abnormal range. The sensor value in the abnormal range having a third priority may be a sensor value that is acquired from a second priority sensor and is most recently acquired among the sensor values in the abnormal range. The sensor value in the abnormal range having a fourth priority may be a sensor value that is acquired from a second priority sensor but is not most recently acquired among sensor values in the abnormal range. The processor 420 according to an embodiment may identify the priority of the sensor value according to a predetermined reference, such as identifying the first to fourth priorities whenever the sensor value is updated, and store sensor values up to the priority within a range allowed by the capacity of the memory 430.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

A non-transitory storage medium storing a program of the disclosure is provided. The program may include instructions configured to cause, when executed by at least one processor (for example, the processor 120 of FIG. 1) of an electronic device (for example, the electronic device 101 of FIG. 1), the electronic device to, based on communication between the electronic device and a first external electronic device and communication between the electronic device and a second external electronic device through communication circuitry, identify a first sensor of the first external electronic device and a second sensor of the second external electronic device corresponding to the first sensor, when a first sensor value sensed by the first sensor is received from the first external electronic device, based on the first external electronic device being worn on a human body, identify whether the first sensor value is a valid value, and, based on the first sensor value being identified as the valid value, transmit a sensor control signal for deactivating the second sensor or changing a first sensing time interval of the second sensor to a second sensing time interval greater than the first sensing time interval to the second external electronic device through the communication circuitry. According to an embodiment of the disclosure, The instructions further configured to cause, when executed by at least one processor (for example, the processor 120 of FIG. 1) of an electronic device (for example, the electronic device 101 of FIG. 1), the electronic device to, receive a second sensing value sensed by the second sensor according to the first sensing time interval, based on the first sensor value not being the valid value.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

In the above discussion, embodiments have been described based on limited embodiments and drawings. However, those skilled in the art may apply various modifications and variations from the above description. For example, appropriate results may be achieved even if the described technologies are performed according to a sequence different from the described methods and/or the described elements such including systems, structures, devices, or circuits are replaced with other elements or equivalents. Therefore, other implementations, other embodiments of the disclosure, and equivalents of the claims fall within the scope of the claims described below.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
communication circuitry;
memory, comprising one or more storage media, storing instructions; and
at least one processor communicatively coupled to the communication circuitry and the memory,
wherein the instructions, when executed by the at least one processor individually or collectively, cause the electronic device to:
identify a first sensor of a first external electronic device and a second sensor of a second external electronic device corresponding to the first sensor based on communications, through the communication circuitry, with the first external electronic device and the second external electronic device,
identify whether a first sensor value is a valid value when the first sensor value sensed by the first sensor is received from the first external electronic device based on the first external electronic device being worn on a human body, and
based on identifying that the first sensor value is the valid value, transmit, to the second external electronic device through the communication circuitry, a sensor control signal to deactivate the second sensor or change a first sensing time interval of the second sensor to a second sensing time interval greater than the first sensing time interval.

2. The electronic device of claim 1, wherein the instructions, when executed by the at least one processor individually or collectively, further cause the electronic device to:
receive a second sensing value sensed by the second sensor according to the first sensing time interval based on the first sensor value not being the valid value.

3. The electronic device of claim 1, wherein the instructions, when executed by the at least one processor individually or collectively, further cause the electronic device to:
identify that the first sensor value is the valid value when the first sensor value is within a valid sensor value range for the first sensor; and
identify that the first sensor value is not the valid value when the first sensor value is not within the valid sensor value range for the first sensor.

4. The electronic device of claim 1, wherein the first sensor includes an acceleration sensor, a temperature sensor, or a heart rate monitoring (HRM) sensor.

5. The electronic device of claim 4, wherein the instructions, when executed by the at least one processor individually or collectively, further cause the electronic device to:
when an acceleration value sensed by the acceleration sensor is within a valid acceleration value range, identify that the acceleration value is the valid value; and
when the acceleration value is not within the valid acceleration value range, identify that the acceleration value is not the valid value.

6. The electronic device of claim 5, wherein the instructions, when executed by the at least one processor individually or collectively, further cause the electronic device to:
when a temperature value sensed by the temperature sensor is within a valid temperature value range, identify that the temperature value is the valid value; and
when the temperature value is not within the valid temperature value range, identify that the temperature value is not the valid value.

7. The electronic device of claim 6, wherein the instructions, when executed by the at least one processor individually or collectively, further cause the electronic device to:
when a bpm value or a brpm value sensed by the HRM sensor is within a valid bpm value range or a brpm value range, identify that the bpm value or the brpm value is the valid value; and
when the bpm value or the brpm value is not within the valid bpm value range or the brpm value range, identify that the bpm value or the brpm value is not the valid value.

8. An electronic device comprising:
communication circuitry;
memory, comprising one or more storage media, storing instructions; and
at least one processor communicatively coupled to the communication circuitry and the memory,
wherein the instructions, when executed by the at least one processor individually or collectively, cause the electronic device to:
identify a first sensor of the electronic device and a second sensor of a second external electronic device corresponding to the first sensor when the electronic device, through the communication circuitry, does not communicate with a first external electronic device and communicates with the second external electronic device,
identify whether a first sensor value is a valid value when the first sensor value sensed by the first sensor is obtained based on identifying the electronic device being worn on a human body, and
transmit, to the second external electronic device through the communication circuitry, a sensor control signal to deactivate the second sensor or change a first sensing time interval of the second sensor to a second sensing time interval greater than the first sensing time interval, and
wherein the second sensing time interval is different from a sensing time interval corresponding to a sensor control signal received by the second external electronic device from the first external electronic device when the second external electronic device is connected to the first external electronic device.

9. The electronic device of claim 8, wherein the instructions, when executed by the at least one processor individually or collectively, further cause the electronic device to:
identify that the first sensor value is the valid value when the first sensor value is within a valid sensor value range for the first sensor; and
identify that the first sensor value is not the valid value when the first sensor value is not within the valid sensor value range for the first sensor.

10. The electronic device of claim 8, wherein the first sensor includes an acceleration sensor, a temperature sensor, or an HRM sensor.

11. A method of controlling an external sensor by an electronic device, the method comprising:
based on communication between the electronic device and a first external electronic device and communication between the electronic device and a second external electronic device through communication circuitry, identifying a first sensor of the first external electronic device and a second sensor of the second external electronic device, corresponding to the first sensor;
in case that a first sensor value sensed by the first sensor is received from the first external electronic device, based on the first external electronic device being worn on a human body, identifying whether the first sensor value is a valid value; and
based on identifying that the first sensor value is the valid value, transmitting, to the second external electronic device through the communication circuitry, a sensor control signal for deactivating the second sensor or changing a first sensing time interval of the second sensor to a second sensing time interval greater than the first sensing time interval.

12. The method of claim 11, further comprising:
receiving a second sensing value sensed by the second sensor according to the first sensing time interval, based on the first sensor value not being the valid value.

13. The method of claim 11, further comprising:
in case that the first sensor value is within a valid sensor value range for the first sensor, identifying that the first sensor value is the valid value; and
in case that the first sensor value is not within the valid sensor value range for the first sensor, identifying that the first sensor value is not the valid value.

14. The method of claim 11, wherein the first sensor comprises an acceleration sensor, a temperature sensor, or an heart rate monitoring (HRM) sensor.

15. The method of claim 14, further comprising:
in case that an acceleration value sensed by the acceleration sensor is within a predetermined valid acceleration value range, identifying that the acceleration value is the valid value; and
in case that the acceleration value is not within the predetermined valid acceleration value range, identifying that the acceleration value is not the valid value.

16. The method of claim 14, further comprising:
in case that a temperature value sensed by the temperature sensor is within a valid temperature value range, identifying that the temperature value is the valid value; and
in case that the temperature value is not within the valid temperature value range, identifying that the temperature value is not the valid value.

17. The method of claim 14, further comprising:
in case that a brpm value or a bpm value sensed by the HRM sensor is within a valid brpm value or bpm value range, identifying that the brpm value or the bpm value is the valid value; and
in case that the brpm value or the bpm value is not within the valid brpm value or bpm value range, identifying that the brpm value or the bpm value is not the valid value.

18. A method of controlling an external sensor by an electronic device, the method comprising:
in case that the electronic device is not connected to communicate with a first external electronic device and is connected to communicate with a second external electronic device through communication circuitry, identifying a first sensor of the electronic device and a second sensor of the second external electronic device, corresponding to the first sensor;
in case that a first sensor value sensed by the first sensor is acquired based on the electronic device being worn on a human body, identifying whether the first sensor value is a valid value; and
based on the first sensor value being the valid value, transmitting, to the second external electronic device through the communication circuitry, a sensor control signal for deactivating the second sensor or changing a sensing period of the second sensor to a second sensing time interval greater than a specified first sensing time interval,
wherein the second sensing time interval is different from a sensing time interval corresponding to a sensor control signal received by the second external electronic device from the first external electronic device in case that the second external electronic device is connected to the first external electronic device.

19. The method of claim 18, further comprising:
in case that the first sensor value is within a valid sensor value range for the first sensor, identifying that the first sensor value is the valid value; and
in case that the first sensor value is not within the valid sensor value range for the first sensor, identifying that the first sensor value is not the valid value.

20. One or more non-transitory computer-readable storage media storing one or more computer programs including computer-executable instructions that, when executed by at least one processor of an electronic device individually or collectively, cause the electronic device to perform operations, the operations comprising:
based on communication between the electronic device and a first external electronic device and communication between the electronic device and a second external electronic device through communication circuitry, identifying a first sensor of the first external electronic device and a second sensor of the second external electronic device, corresponding to the first sensor;
in case that a first sensor value sensed by the first sensor is received from the first external electronic device, based on the first external electronic device being worn on a human body, identifying whether the first sensor value is a valid value; and
based on identifying that the first sensor value is the valid value, transmitting, to the second external electronic device through the communication circuitry, a sensor control signal for deactivating the second sensor or changing a first sensing time interval of the second sensor to a second sensing time interval greater than the first sensing time interval.
